(19) United States
(12) Patent Application Publication
(10) Pub. No.: US 2015/0356610 A1
(43) Pub. Date: Dec. 10, 2015

(54) Realtime Realworld and Online Activity Correlation and Inventory Management Apparatuses, Methods and Systems

(71) Applicant: Symphony Teleca Corporation, Mountain View, CA (US)

(72) Inventor: Sweeni S. Ponoth, Carrollton, TX (US)

(21) Appl. No.: 14/732,759

(22) Filed: Jun. 7, 2015

Related U.S. Application Data
(60) Provisional application No. 62/009,227, filed on Jun. 7, 2014.

(51) Int. Cl. G06Q 30/02; G06Q 10/08

(52) U.S. Cl. CPC G06Q 30/0261; G06Q 10/087

(57) ABSTRACT

The Realtime Realworld and Online Activity Correlation and Inventory Management Apparatuses, Methods and Systems (“RROACIM”) transforms offer determining request, traffic analyzing request, video data and Beacon data inputs via RROACIM components into applicable offer and traffic metrics outputs. A consumer device identifier may be obtained from a beacon receiver and consumer preference information may be retrieved. An approximate consumer and consumer device position may be determined. The RROACIM may obtain realtime video feed targeted at the approximate consumer and consumer device position, generate frame models of consumers in that targeted position, and determine which frame is of the target consumer. The RROACIM may correlate movements of the frame model with the consumer and consumer device and determine intentionality of the consumer. The RROACIM may generate inquiries for the consumer and generate shelf tag update messages to be displayed to the consumer.

### PRIORITY CLAIM

Applicant hereby claims benefit to priority under 35 USC 5119 as a non-provisional conversion of: U.S. provisional patent application Ser. No. 62/009,227, filed Jun. 7, 2014, entitled “Realtime Realworld and Online Activity Correlation and Inventory Management Apparatuses, Methods and Systems,” (attorney docket no. SCT-0002PV).

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

The entire contents of the aforementioned application are herein expressly incorporated by reference.

### FIELD

The present innovations generally address inventory control, and more particularly, include Realtime Realworld and Online Activity Correlation and Inventory Management Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Many retail outlets employ inventory systems to track inventory levels at a particular location. These systems often rely on barcodes being applied to each product offering placed on shelves, and deducting from inventory levels upon checkout.

### BRIEF DESCRIPTION OF THE DRAWINGS

Appendices and/or drawings illustrating various, non-limiting, example, innovative aspects of the Realtime Realworld and Online Activity Correlation and Inventory Management Apparatuses, Methods and Systems (hereinafter “RROACIM”) disclosure, include:

FIGS. 1A-1B show datagraph diagrams illustrating embodiments of an offer determining data flow for the RROACIM;

FIG. 2 shows a logic flow diagram illustrating embodiments of an offer determining (OD) component for the RROACIM;

FIG. 3 shows a screenshot diagram illustrating embodiments of the RROACIM;

FIG. 4 shows a screenshot diagram illustrating embodiments of the RROACIM;

FIG. 5 shows a screenshot diagram illustrating embodiments of the RROACIM;

FIG. 6 shows a screenshot diagram illustrating embodiments of the RROACIM;

FIG. 7 shows a screenshot diagram illustrating embodiments of the RROACIM;

FIG. 8 shows a screenshot diagram illustrating embodiments of the RROACIM;

FIG. 9 shows a screenshot diagram illustrating embodiments of the RROACIM;

FIG. 10 shows a screenshot diagram illustrating embodiments of the RROACIM;

FIG. 11 shows a screenshot diagram illustrating embodiments of the RROACIM;

FIG. 12 shows a screenshot diagram illustrating embodiments of the RROACIM;

FIG. 13 shows a screenshot diagram illustrating embodiments of the RROACIM;

FIG. 14 shows a screenshot diagram illustrating embodiments of the RROACIM;

FIG. 15 shows a screenshot diagram illustrating embodiments of the RROACIM;

FIG. 16 shows a screenshot diagram illustrating embodiments of the RROACIM;

FIG. 17 shows a screenshot diagram illustrating embodiments of the RROACIM;

FIG. 18 shows a datagraph diagram illustrating embodiments of a traffic analyzing data flow for the RROACIM;

FIG. 19 shows a logic flow diagram illustrating embodiments of a traffic analyzing (TA) component for the RROACIM;

FIG. 20 shows a screenshot diagram illustrating embodiments of the RROACIM;

FIG. 21 shows a screenshot diagram illustrating embodiments of the RROACIM;

FIG. 22 shows a screenshot diagram illustrating embodiments of the RROACIM;

FIG. 23 shows a screenshot diagram illustrating embodiments of the RROACIM;

FIG. 24 shows a screenshot diagram illustrating embodiments of the RROACIM;

FIG. 25 shows a screenshot diagram illustrating embodiments of the RROACIM;

FIG. 26 shows a screenshot diagram illustrating embodiments of the RROACIM;

FIG. 27 shows a screenshot diagram illustrating embodiments of the RROACIM; and

FIG. 28 shows a block diagram illustrating embodiments of a RROACIM controller.

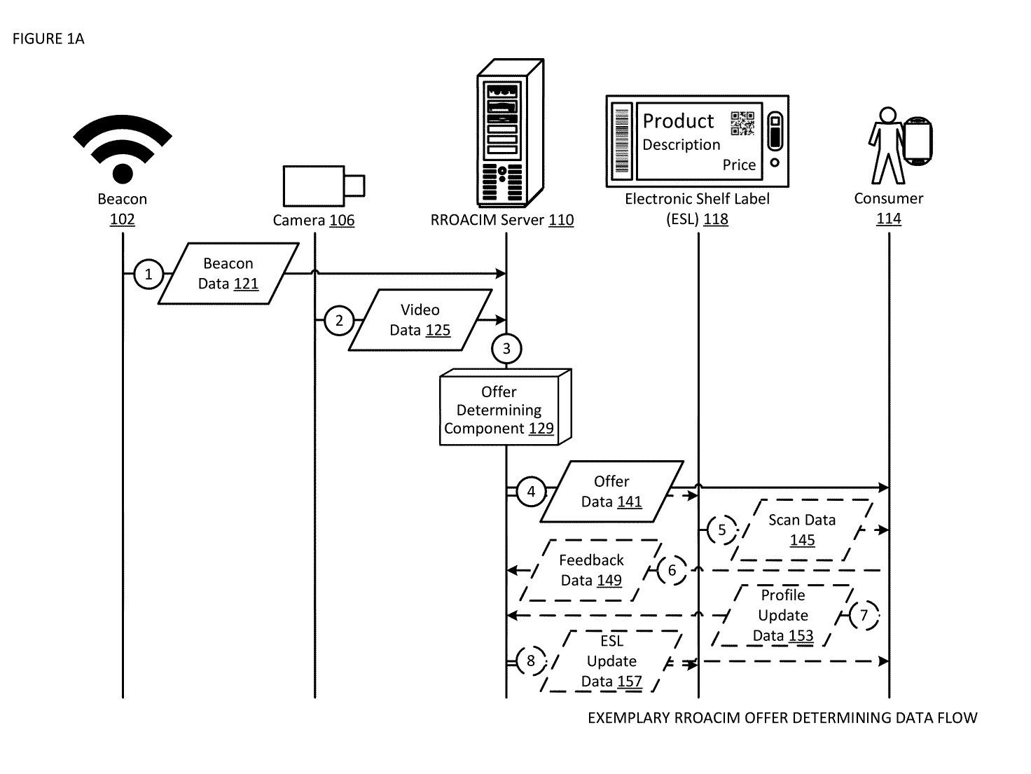

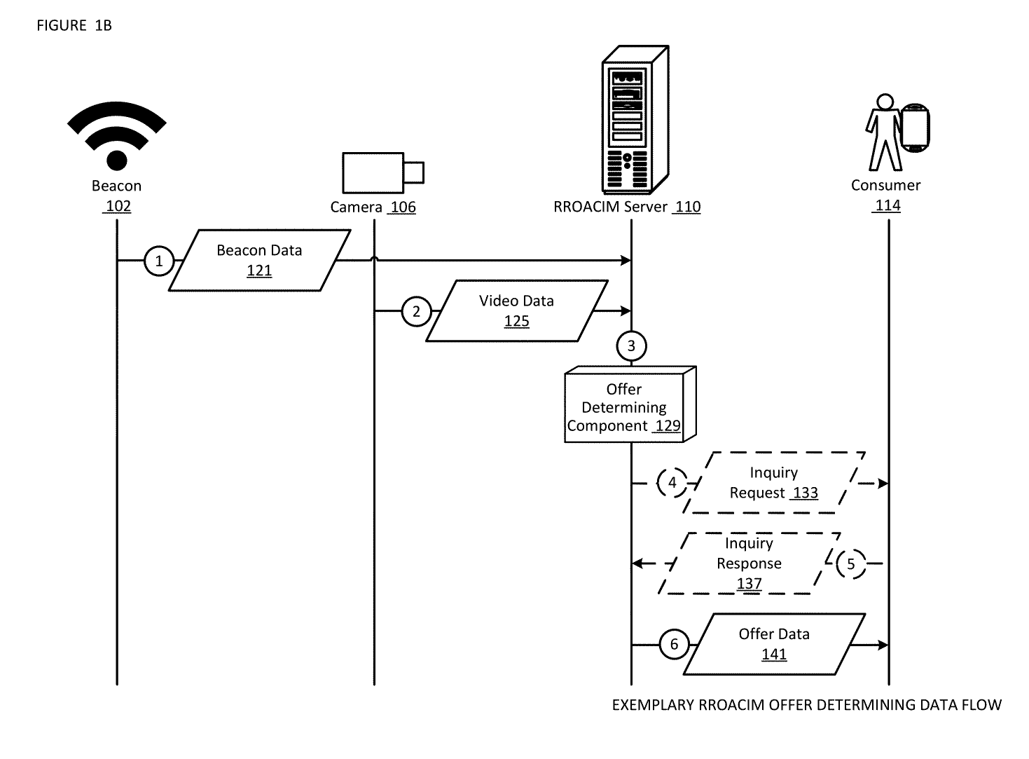

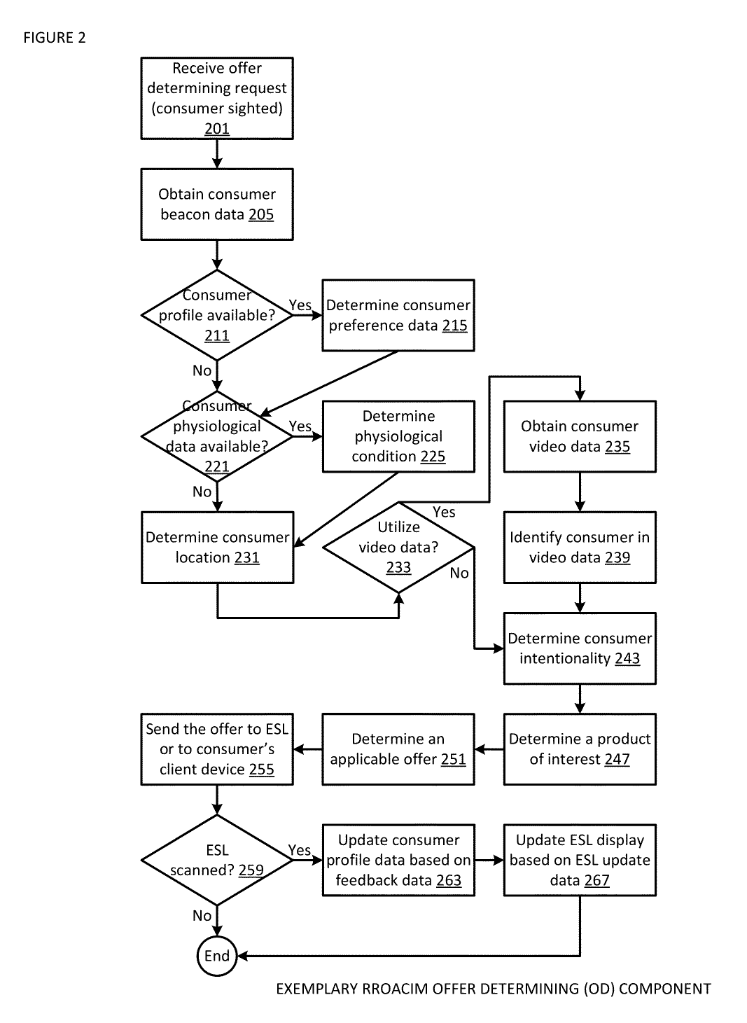

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Realtime Realworld and Online Activity Correlation and Inventory Management Apparatuses, Methods and Systems (hereinafter “RROACIM”) transforms offer determining request, traffic analyzing request, video data and Beacon data inputs, via RROACIM components (e.g., OD, TA, etc.), into applicable offer and traffic metrics outputs. The RROACIM components, in various embodiments, implement advantageous features as set forth below.

### Introduction

In one embodiment, RROACIM provides a next generation inventory and activity analytics and prediction. In one embodiment, RROACIM obtains information from consumer devices (e.g., UUIDs, MAC addresses, consumer identifier, GPS location data, physiological data, etc. via Beacons, Bluetooth, Cellular, Internet, NFC, retail store radio frequency and magnetic security gates, WiFi, etc. hereinafter “Beacons”). RROACIM may also employ security and other camera systems (e.g., Microsoft Kinect, infrared, etc.) for live feeds of video of consumers entering and/or leaving a retail establishment, and for monitoring known positions throughout a retail establishment. By correlating Beacon entries of unique identifiers of consumers known to be in approximate locations within a retail space, with live feed camera analysis, RROACIM may pinpoint exactly where a consumer is, how long they are there, the direction the consumer is facing, the body language, as well as facial expression and glance direction of an individual. Further, how long a consumer spent at a location may be determined by recording the entry and/or exit times within a beacon's range (e.g., based on entry and/or exit times determined using video analytics, and/or based on entry and/or exit times recorded by the beacon). The camera feed may be analyzed to build a wire frame representation of the human frame, as well as the face and eyes to track such activity. This live feed information, correlated with the Beacon information allows RROACIM to deduce the intentionality of a consumer. For example, if the consumer is searching a series of aisles, it may be indicative that the consumer cannot find a desired item. In such an instance, RROACIM may send the consumer a message to their device, asking if the consumer needs help, and may receive a response from the consumer, what specific item the consumer is interested in. If the product is in a different location, RROACIM may provide a bread-crumb-trail to the consumer to guide the consumer to the exact aisle and shelf location of a product; e.g., via in-store GPS mapping, and/or sent to a wearable or augmented reality device so that the consumer may place the device in front of their eyes to get a highlighted overlay to the desired product. If the item is not available, this information may be aggregated to place orders and increase inventory for popular items. Further, in order to avoid a lost sale, a consumer may be directed to the retailer's e-commerce site where the consumer may place an order (e.g., with one click) and/or get expedited shipping and/or a special discount. Similarly, if consumers hover by items, and in aggregate do not buy, this may provide indication to lower inventory/ordering levels in the future. RROACIM, may also provide offers to consumers hovering in front of a product, to entice their purchase. RROACIM may leverage consumer profile preference information in providing such offers. Further, smart shelf price tags may be updated when an identified consumer approaches to show them discounted prices if they “buy now” and/or show profile points that could be used to discount items. Also, the tags may be used to show a comparison of the price of a gazed upon product to that of other stores in the area or stores the consumer frequents to show that the price on the shelf is preferable (or not) and further entice a purchase.

### RROACIM

FIGS. 1A-1B show a datagraph diagram illustrating embodiments of a data flow for the RROACIM. In FIGS. 1A-1B, dashed lines indicate data flow elements that may be more likely to be optional. In one embodiment, in FIG. 1A, a Beacon device (e.g., a transceiver) 102 associated with a consumer device (e.g., a tablet, a smartphone, a device integrated into a car) may send beacon data 121 to a RROACIM server 110. Alternatively, a Beacon device may also be an in-store beacon (e.g., a Bluetooth beacon). For example, the Beacon device may send beacon data when a consumer carrying the consumer device enters a retail establishment and receives a UUID of the retailer's Bluetooth low energy beacon. In another example, a consumer may drive by a retail establishment (e.g., a drive through) in a car equipped with the Beacon device. In one implementation, beacon data may include a consumer device identifier, a Beacon device identifier, a consumer identifier, location data, physiological data, consumer preference data, and/or the like. For example, the Beacon device may provide the following example beacon data, substantially in the form of a (Secure) Hypertext Transfer Protocol (“HTTP(S)”) POST message including eXtensible Markup Language (“XML”) formatted data, as provided below:

```
POST /beacon_data.php HTTP/1.1
Host: www.server.com
Content-Type: Application/XML
Content-Length: 667
<?XML version = “1.0” encoding = “UTF-8”?>
<beacon_data>
    <consumer_device_identifier>UUID of the device
    </consumer_device_identifier>
    <consumer_identifier>ID_Consumer1</consumer_identifier>
    <location>GPS location</location>
    <beacon_identifier>Beacon UUID</beacon_identifier>
</beacon_data>
```

A camera 106 (e.g., a video camera in the retail establishment) may send video data 125 associated with the consumer's approximate location to the RROACIM server. For example, the consumer's approximate location may be determined based on location data, and video feeds from one or more cameras associated with GPS coordinates provided in the location data may be provided (e.g., sent to the server, identified from a plurality of video feeds that are continuously received by the server) to the RROACIM server. In one implementation, video data may be sent as a video file (e.g., in AVI file format) or stream.

The RROACIM server may determine an offer for the consumer using an offer determining (OD) component 129. In various implementations, the OD component may utilize beacon data, video data, consumer profile data, traffic metrics associated with the retail establishment (e.g., determined using a traffic analyzing (TA) component), competitor prices, and/or the like to determine an offer for the consumer. For example, an offer tailed to the consumer's preferences may be generated. In another example, if it is noted (e.g., based on analysis of video data) that a region in the retail establishment tends to be empty or have low traffic, a blue light special discount may be offered on products in that region and an offer informing the consumer regarding the blue light special discount may be generated. See FIG. 2 for additional details regarding the OD component.

The RROACIM server may send offer data 141 to the consumer (e.g., using an alert in a mobile app, using SMS) or to an electronic shelf label (ESL) 118 to present the determined offer to the consumer. In various embodiments, the ESL may be an ESL device, an NFC tag, a WiFi device, a Bluetooth device, a sticker with a QR or barcode, and/or the like and may be located on a shelf, on a shelf talker, on a price label, and/or the like. For example, the consumer device may show and updated (e.g., discounted) price to the consumer, or the ESL may show an updated (e.g., discounted) price to the consumer and the consumer may take advantage of the offer (e.g., by providing the consumer identifier at the register using a Beacon device). In another example, the consumer may scan a QR code associated with the offer with the consumer device using a mobile app to take advantage of the offer (e.g., by presenting the scanned QR code at the register). In one implementation, offer data may include an offer identifier, a product identifier, a description, an expiration date and/or time, a price, a consumer device identifier, a consumer identifier, a barcode (e.g., a QR code), an ESL identifier, and/or the like. For example, the RROACIM server may provide the following example offer data, substantially in the form of a HTTP(S) POST message including XML-formatted data, as provided below:

```
POST /offer_data.php HTTP/1.1
Host: www.server.com
Content-Type: Application/XML
Content-Length: 667
<?XML version = “1.0” encoding = “UTF-8”?>
<offer_data>
    <offer_identifier>ID_Offer1</offer_identifier>
    <product_identifier>ID_Product1</product_identifier>
    <offer_description>Buy within the next hour to get 20%
off!</offer_description>
    <expiration>date and time of offer expiration</expiration>
    <price>$16</price>
    <consumer_identifier>ID_Consumer1</consumer_identifier>
    <barcode_data>QR code that may be scanned by the consumer to
utilize the offer</barcode_data>
    <ESL_identifier>ID of ESL that displays the offer to the
consumer</ESL_identifier>
</offer_data>
```

In some embodiments, the consumer may utilize the consumer device 114 to obtain scan data 145 to take advantage of the offer. For example, the consumer may scan (e.g., take a photo of) a QR code associated with the offer. In another example, the consumer may tap on an NFC enabled ESL to scan data associated with the offer. In yet another example, the consumer may tap on an NFC enabled ESL to purchase a product (e.g., the product may be delivered to the register when the consumer is ready to check out, the product may be mailed to the consumer's home). In various implementations, scan data may include a photo of the QR code, an offer identifier sent by the NFC enabled ESL, a purchase order identifier provided by the RROACIM server via the NFC enabled ESL, and/or the like.

In some embodiments, the mobile app running on the consumer device may send feedback data 149 to the RROACIM server. In one implementation, feedback data may include scan details and/or purchase order details. For example, the retailer's mobile app running may inform the RROACIM server whether a coupon associated with the offer was scanned by the consumer, whether the consumer added a product associated with the offer to a shopping cart (e.g., to reserve the product at the consumer's special price), may provide the RROACIM server with a timestamp (e.g., date and/or time) associated with the scan or purchase, may inform the RROACIM server that the consumer wishes to access the retailer's e-commerce website, and/or the like.

Similarly, the consumer device (e.g., running the retailer's mobile app) may send profile update data 153 to the RROACIM server. In one implementation, profile update data may include data such as updated coupons associated with the consumer (e.g., based on the consumer scanning a coupon), updated products purchased by the consumer (e.g., based on the consumer purchasing a product), an updated profile photo (e.g., taken by a front facing camera of the consumer device or taken by the retailer's nearby camera to update the consumer's profile with a more recent photo), updated preferences, updated shopping list, and/or the like. For example, the consumer device may provide the following example profile update data, substantially in the form of a HTTP(S) POST message including XML-formatted data, as provided below:

```
POST /profile_update_data.php HTTP/1.1
Host: www.server.com
Content-Type: Application/XML
Content-Length: 667
<?XML version = “1.0” encoding = “UTF-8”?>
<profile_update_data>
    <consumer_device_identifier>UUID of the device
    </consumer_device_identifier>
    <consumer_identifier>ID_Consumer1</consumer_identifier>
    <coupon_data>updated list of coupons associated with the
consumer</coupon_data>
    <profile_photo>updated photo of the consumer</profile_photo>
    <timestamp>date and/or time</timestamp>
</profile_update_data>
```

In some embodiments, the RROACIM server may send ESL update data 157 to the consumer device and/or to the ESL. In one implementation, ESL update data may be used to update the retailer's mobile app screen and/or the ESL in response to an action taken by the consumer. For example, if the consumer decided to add a product to the consumer's digital shopping cart, a screen of the mobile app may be updated to indicate to the consumer that the product was successfully added to the digital shopping cart, that the product is out of stock, and/or the like.

In another embodiment, in FIG. 1B, a Beacon device (e.g., a transceiver) 102 associated with a consumer device (e.g., a tablet, a smartphone, a device integrated into a car) may send beacon data 121 to a RROACIM server 110. For example, the Beacon device may send beacon data when a consumer carrying the consumer device “sights” a sports drink in a retail establishment. In various implementations “sight” may mean that the consumer has stepped into a beacon's range, that the consumer has tapped on NFC tag enabled ESL or shelf talker or price label, that the consumer has scanned a barcode or a QR code, and/or the like. In one implementation, beacon data may include a consumer device identifier, a Beacon device identifier, a consumer identifier, location data, physiological data, consumer preference data, a sensor identifier, and/or the like. For example, the Beacon device may provide the following example beacon data, substantially in the form of a HTTP(S) POST message including XML-formatted data, as provided below:

```
POST /beacon_data.php HTTP/1.1
Host: www.server.com
Content-Type: Application/XML
Content-Length: 667
<?XML version = “1.0” encoding = “UTF-8”?>
<beacon_data>
    <consumer_device_identifier>UUID of the device
    </consumer_device_identifier>
    <consumer_identifier>ID_Consumer2</consumer_identifier>
    <physiological_data>consumer is dehydrated</physiological_data>
    <sensor_identifier>identifier of the sensor tapped by the
consumer</sensor_identifier>
</beacon_data>
```

A camera 106 (e.g., a video camera in the retail establishment) may send video data 125 associated with the consumer's approximate location to the RROACIM server. For example, the consumer's approximate location may be determined based on the sensor (e.g., NFC tag and/or beacon) identifier, and/or video feeds from one or more cameras associated with the approximate location may be provided (e.g., sent to the server, identified from a plurality of video feeds that are continuously received by the server) to the RROACIM server. In one implementation, video data may be sent as a video file (e.g., in AVI file format) or stream.

The RROACIM server may determine an offer for the consumer using an offer determining (OD) component 129. In various implementations, the OD component may utilize beacon data, video data, consumer profile data, traffic metrics associated with the retail establishment (e.g., determined using a traffic analyzing (TA) component), competitor prices, and/or the like to determine an offer for the consumer. See FIG. 2 for additional details regarding the OD component.

The RROACIM server may send an inquiry request 133 to the consumer device of a consumer 114. The inquiry request may be utilized to determine whether the consumer wishes to find out about the offer. For example, the OD component may determine that the consumer should be offered a 20% discount on the sports drink (e.g., because the consumer is dehydrated) in exchange for taking a quick survey. Accordingly, the inquiry request may be sent to determine whether the consumer wishes to take the survey in exchange for a 20% off coupon. In another example, the OD component may determine (e.g., based on consumer preference data in the consumer's profile and based on the consumer's movement through the retail establishment) that even though the consumer was sighted by the sensor associated with sports drink A, the consumer prefers sports drink B and the consumer's movement indicates that the consumer cannot find sports drink B. Accordingly, the inquiry request may be sent to ask the consumer whether the consumer would like directions to the location of sports drink B. In one implementation, the inquiry request may include data such as an inquiry identifier, a product identifier, a description, condition data, a consumer device identifier, and/or the like. For example, the RROACIM server may provide the following example inquiry request, substantially in the form of a HTTP(S) POST message including XML-formatted data, as provided below:

```
POST /inquiry_request.php HTTP/1.1
Host: www.server.com
Content-Type: Application/XML
Content-Length: 667
<?XML version = “1.0” encoding = “UTF-8”?>
<inquiry_request>
    <inquiry_identifier>ID_Inquiry2</inquiry_identifier>
    <product_identifier>ID_Product2</product_identifier>
    <description>Take a quick survey to get 20% off!</description>
    <condition_data>survey data</condition_data>
    <consumer_device_identifier>UUID of the device
    </consumer_device_identifier>
</inquiry_request>
```

The consumer may utilize the consumer device to send an inquiry response 137 to the RROACIM server. For example, the consumer may agree to take the survey and fill out the survey. In another example, the consumer may indicate that the consumer would like directions to the location of sports drink B. In one implementation, the inquiry response may include data such as an inquiry identifier, response data, a consumer device identifier, and/or the like. For example, the consumer device may provide the following example inquiry response, substantially in the form of a HTTP(S) POST message including XML-formatted data, as provided below:

```
POST /inquiry_response.php HTTP/1.1
Host: www.server.com
Content-Type: Application/XML
Content-Length: 667
<?XML version = “1.0” encoding = “UTF-8”?>
<inquiry_response>
    <inquiry_identifier>ID_Inquiry2</inquiry_identifier>
    <response_data>survey response data</response_data>
    <consumer_device_identifier>UUID of the device
    </consumer_device_identifier>
</inquiry_response>
```

The RROACIM server may send offer data 141 to the consumer device of the consumer to present the determined offer to the consumer. For example, the RROACIM server may send an electronic coupon to the consumer device and the consumer may take advantage of the offer by providing the electronic coupon at the register (e.g., using the screen of the consumer device). In another example, the RROACIM server may send directions to the location of sports drink B. In one implementation, offer data may include an offer identifier, a product identifier, a description, an expiration date and/or time, a consumer identifier, a coupon (e.g., a QR code), directions data, and/or the like. For example, the RROACIM server may provide the following example offer data, substantially in the form of a HTTP(S) POST message including XML-formatted data, as provided below:

```
POST /offer_data.php HTTP/1.1
Host: www.server.com
Content-Type: Application/XML
Content-Length: 667
<?XML version = “1.0” encoding = “UTF-8”?>
<offer_data>
    <offer_identifier>ID_Offer2</offer_identifier>
    <product_identifier>ID_Product2</product_identifier>
    <offer_description>Get 20% off your sports drink!
    </offer_description>
    <expiration>date and time of coupon expiration</expiration>
    <consumer_identifier>ID_Consumer2</consumer_identifier>
    <coupon_data>QR code coupon that may be used by the consumer
at the register</coupon_data>
</offer_data>
```

FIG. 2 shows a logic flow diagram illustrating embodiments of an offer determining (OD) component for the RROACIM. In FIG. 2, an offer determining request may be received when a consumer is sighted by a sensor at 201. For example, the offer determining request may be received when it is determined that the consumer entered a retail establishment, activated a mobile app associated with the retail establishment on the consumer's consumer device (e.g., a tablet, a smartphone), tapped an ESL, and/or the like.

Beacon data associated with the consumer may be obtained at 205. In one embodiment, beacon data may be obtained using one or more Beacon devices of the consumer device. For example, the consumer device's beacon receiver may receive a UUID of the retailer's Bluetooth low energy beacon and, in response, the consumer device may launch the retailer's mobile app, which may use the consumer device's mobile (e.g., LTE, WiFi) transceiver to send beacon data to the retailer (e.g., after performing security checks and/or requesting the consumer to log in). Beacon data received from the consumer device may be parsed (e.g., using PHP commands) to determine its contents.

A determination may be made at 211 whether a consumer profile is available for the consumer. In one embodiment, a determination may be made whether the obtained beacon data includes an identifier (e.g., a consumer device identifier, a Beacon device identifier, a consumer identifier) associated with the consumer and/or whether the identifier is associated with a valid consumer profile. In various implementations, a consumer profile may include a consumer's demographic information (e.g., age, gender, education level, income level, zip code), physical description (e.g., a photo, weight, height), retailer-specific information (e.g., reward points with the retailer, available electronic coupons), consumer preferences (e.g., owned products, product preferences, brand preferences, discount type preferences (e.g., preference for percent off, dollar amount off, or buy one get one free type offers)), a combination of various (e.g., public, private, structured, unstructured) data streams utilized to build a digital persona, and/or the like.

If it is determined that a consumer profile is available, consumer preference data and/or other profile data utilized to determine an applicable offer and/or an engagement mechanism (link to a multimedia, survey, appreciation, personal greeting, etc.) for the consumer and/or utilized to help identify the consumer in video data may be determined at 215. In one implementation, consumer preference data may be determined via a MySQL database command similar to the following:

SELECT consumerPreferenceData
FROM ConsumerAccounts
WHERE consumerID=”ID_Consumer1”;

A determination may be made at 221 whether physiological data is available for the consumer. In one embodiment, a determination may be made whether the obtained beacon data includes physiological data (e.g., heart rate, blood pressure, hydration level, activity level) associated with the consumer. For example, physiological data may be tracked by the consumer device and/or by an auxiliary wearable device (e.g., a fitness tracker). If it is determined that physiological data is available, physiological condition associated with the consumer may be determined at 225. For example, physiological data may be analyzed to determine whether the consumer is dehydrated, interested in a product (e.g., elevated heart rate when looking at a sports car), should take medicine (e.g., high blood pressure), and/or the like.

The consumer's approximate location may be determined at 231. In one embodiment, the consumer's approximate location may be included in the obtained beacon data. For example, a GPS associated with the consumer device may determine the consumer's coordinates, which may be included in the beacon data. In another embodiment, the consumer's approximate location may be determined based on Beacon communication. For example, location of the specific Bluetooth low energy beacon that communicated with the consumer device and/or the signal strength and/or directionality of the connection may be determined and utilized to approximate the consumer's location. In another example, location of the NFC tag tapped by the consumer may be determined and utilized to approximate the consumer's location. In another example, when a consumer scans a unique bar/QR code at a known location, the consumer's location can be determined by referencing the location of the bar/QR code as registered on the server. In yet another embodiment, the consumer's approximate location may be determined using triangulation of nearby WiFi signals. For example, the Wifi transmitters may be setup by the retailer at known locations within the retail environment.

A determination may be made at 233 whether video data should be utilized. For example, video data may be utilized to obtain additional details and/or to help determine and/or confirm the consumer's intentionality with a greater degree of certainty. In one implementation, video data may be utilized if the consumer's intentionality is not determined with a predefined threshold level of certainty (e.g., at least 75% level of certainty).

If it is determined that video data should be utilized, video data associated with the consumer may be obtained at 235. In one embodiment, one or more cameras recording video data of the consumer's approximate location may be determined, and real-time video data may be obtained from such cameras. In another embodiment, one or more video streams associated with the consumer's approximate location may be identified and retrieved.

The consumer may be identified in the obtained video data at 239. In one embodiment, the video data may be analyzed to determine frame models of consumers in the consumer's approximate location. For example, if there is a single frame model in the consumer's approximate location (e.g., at video timestamp that matches the timestamp when the NFC tag was tapped by the consumer or when the consumer entered the range of a known beacon), it may be determined that the frame model is of the consumer. In another example, movements of frame models in the video data may be correlated with changes in the approximate location provided in beacon data, and utilized to determine which frame model is of the consumer. In another embodiment, the consumer's profile data may be utilized to identify the consumer. For example, frame models in the video data may be analyzed with regard to the consumer's demographic information and/or physical description (e.g., age, gender, photo, weight, height, and/or the like) to determine which frame model is of the consumer. In some implementations, frame models may be analyzed to classify the consumer (e.g., single vs. couple, adult vs. child).

The consumer's intentionality may be determined at 243. In one implementation, the identified frame model of the consumer may be analyzed to determine the consumer's exact location, how long the consumer hovers by a product, the direction the consumer is facing, the consumer's body language, facial expression, glance direction, and/or the like. In another implementation, the consumer's profile data and/or physiological data may also be analyzed. In one embodiment, such data may be used to predict whether the consumer is interested in purchasing a product. For example, if the consumer hovers by a product for a predetermined minimum amount of time and looks at the product, it may be determined that the consumer may be interested in the product. In another example, if the consumer tapped an NFC tag associated with a product, it may be determined that the consumer may be interested in the product. In another embodiment, such data may be used to predict whether the consumer is unable to find a product of interest. For example, if the consumer's profile indicates that the consumer owns a MacBook Pro, but the consumer is hovering by an aisle with MacBook Air power adapters, it may be determined that the consumer is unable to find a power adapter for a MacBook Pro. In another example, video analysis of the inventory level may indicate that the consumer is standing by an empty shelf, and it may be determined that the consumer is unable to find a product of interest because it is out of stock. Further, a notification may be issued (e.g., to retailer personnel) to restock the product on the shelf. In yet another embodiment, such data may be used to predict the direction (e.g., a shelf, an aisle, predicted path) in which the consumer is heading. For example, the consumer's shopping list (e.g., obtained from a mobile app running on the consumer device as part of beacon data) and/or previous traffic patterns may be correlated with movement of the consumer's frame model to predict where the consumer is going.

A product of interest to the consumer may be determined at 247. In one embodiment, if it is predicted that the consumer may be interested in purchasing a product, this product may be selected as the product of interest. In another embodiment, if it is predicted that the consumer may be interested in purchasing a product, a substitute or complimentary product may be selected as the product of interest. For example, if the consumer is looking at a product that is out of stock, a similar product may be selected as the product of interest. In another example, a more full featured and/or less expensive product may be selected (e.g., based on the consumer's income level) as the product of interest. In yet another example, if it is predicted that the consumer is looking at the wrong item (e.g., a power supply for a MacBook Air) for the consumer, an appropriate item (e.g., a power supply for a MacBook Pro) may be selected (e.g., based on the analysis of the consumer's profile data, by prompting the consumer to specify the appropriate item) as the product of interest. In yet another embodiment, if it is predicted that the consumer is heading toward an isle with a product that the retailer would like to offer to the consumer (e.g., based on the consumer's preference data and status as a platinum customer, based on a blue light discount special in that isle), this product may be selected as the product of interest.

An applicable offer for the consumer may be determined at 251. In various implementations, the consumer's profile data, physiological data, intentionality, traffic metrics associated with the retail establishment, competitor prices, classification type, and/or the like may be used to determine an applicable offer for the consumer. In one embodiment, the offer may be a special price on the product of interest. For example, the consumer may be offered a lower price to encourage the consumer to purchase the product of interest. In another example, traffic metrics may indicate that there is high consumer traffic during certain time periods (e.g., certain hours, certain days of the week), and low consumer traffic during other time periods. Accordingly, the price for the product of interest may be increased during high traffic time periods and decreased during low traffic time periods to encourage a more even distribution of consumer traffic. In another embodiment, the offer may be a coupon for the product of interest. For example, the consumer may be offered a buy two get one free coupon to entice the consumer to purchase a bigger quantity of the product of interest. In another example, the consumer may be offered a 20% off coupon for the product of interest for filling out a survey. In yet another embodiment, the offer may be an offer to help find the product of interest. For example, the retailer may provide directions to the product of interest. In yet another embodiment, the offer may be an offer to show a comparison of the price of the product of interest to that of other stores in the area or other stores (e.g., including online stores) the consumer frequents. For example, the retailer may show how the price of the product of interest compares to that of competitors and/or may offer to price match a competitor's price (e.g., for platinum customers).

The applicable offer may be sent to an ESL and/or to the consumer's client device at 255. In one embodiment, the offer may be sent to the ESL tapped by the consumer. For example, the ESL may display an updated price, a coupon, and/or the like. In another embodiment, the offer may be sent to the consumer device. For example, the offer (e.g., a survey and a coupon for taking the survey) may be displayed on the screen of the consumer device using the retailer's mobile app. In another example, directions to the product of interest may be provided to the consumer device and displayed (e.g., on the screen of the consumer device, using an auxiliary wearable or augmented reality device) to the consumer.

A determination may be made at 259 whether the consumer scanned the ESL. In one embodiment, a determination may be made whether the consumer scanned a bar code displayed on the screen of the ESL (e.g., based on data provided by the retailer's mobile app executing on the consumer device) associated with the offer. In another embodiment, a determination may be made whether the consumer tapped on an NFC enabled ESL to scan data associated with the offer.

If it is determined that the consumer scanned the ESL, feedback data associated with the consumer may be obtained at 263. In one embodiment, feedback data may be obtained from the ESL and/or from another device acting in concert with the ESL (e.g., a video camera that takes an updated photo of the consumer). In another embodiment, feedback data may be obtained from the consumer device (e.g., the consumer device may send an updated list of coupons associated with the consumer). The obtained feedback data may be utilized to update the consumer's profile data (e.g., the updated photo indicates that the consumer changed the color of his or her hair).

ESL update data may be provided to the ESL at 267. In one embodiment, the ESL may utilize this data to update its screen with a message for the consumer (e.g., to indicate to the consumer that the product of interest was successfully added to the digital shopping cart, that the product of interest is out of stock). In another embodiment, the ESL may utilize this data to update its screen with data relevant to other customers. For example, the ESL may show the updated price (e.g., the undiscounted price, a new price based on the amount of remaining inventory) and/or available quantity of the product of interest.

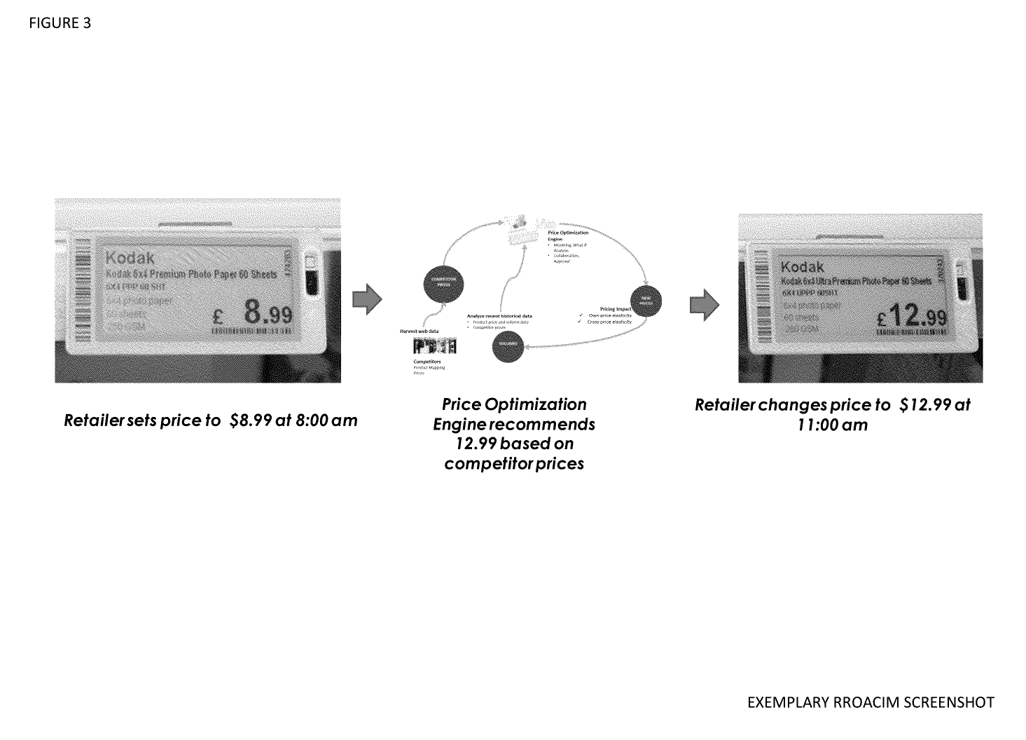

FIG. 3 shows a screenshot diagram illustrating embodiments of the RROACIM. In FIG. 3, a retailer may set the price of photo paper to $8.99 at 8:00 am and the ESL associated with this product may be updated to reflect this price. Based on traffic metrics associated with the retailer (e.g., high traffic starting at 11 am) and/or competitor prices, the price of the photo paper may be changed to $12.99 at 11:00 am to optimize profit margins and/or to encourage consumers to come into the store earlier in the day. Alternatively, the price may be decreased if it is detected that consumers are coming by to view the product but are not purchasing the product, or the price may be increased if there is little inventory left on the shelf (e.g., 1 out of 5 boxes of photo paper remain). The ESL associated with this product may be updated to reflect the new price.

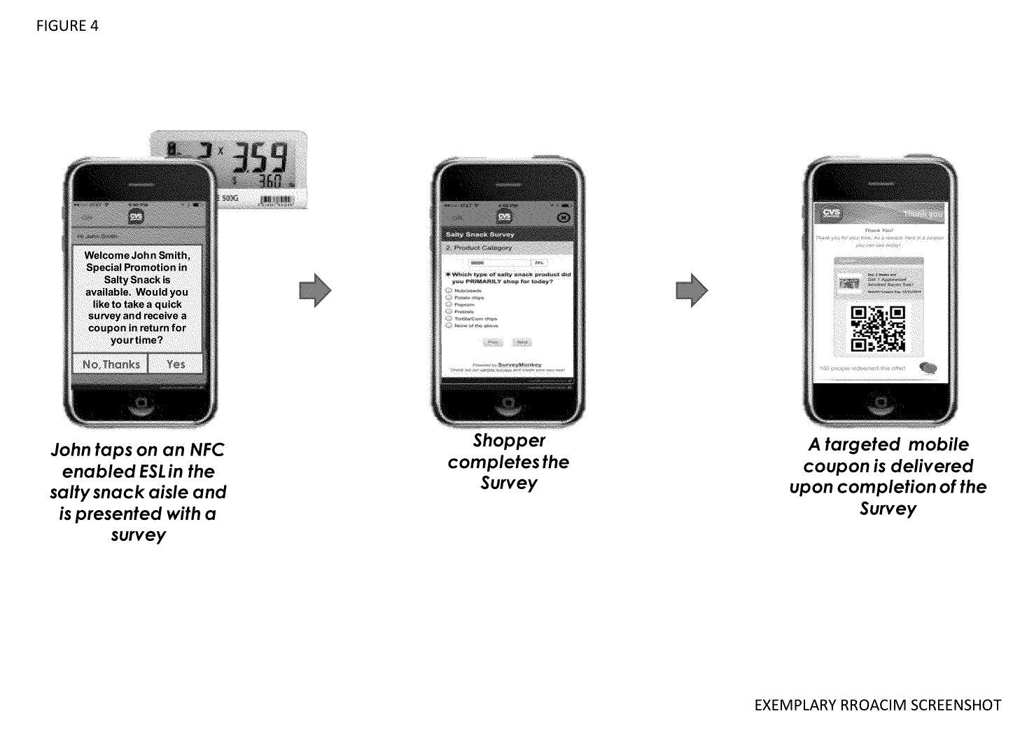

FIG. 4 shows a screenshot diagram illustrating embodiments of the RROACIM. In FIG. 4, a consumer, John, opens a retailer's mobile app and taps on an NFC enabled ESL of a product in the salty snack aisle. An offer to fill out a survey to receive a coupon may be presented to the consumer. Upon completion of the survey, a targeted mobile coupon is delivered to the consumer (e.g., a coupon to buy two and get one free of the product associated with the ESL, a coupon for 20% off a nearby product that John was looking at with curiosity). For example, the coupon may be a QR code delivered to the consumer's smartphone.

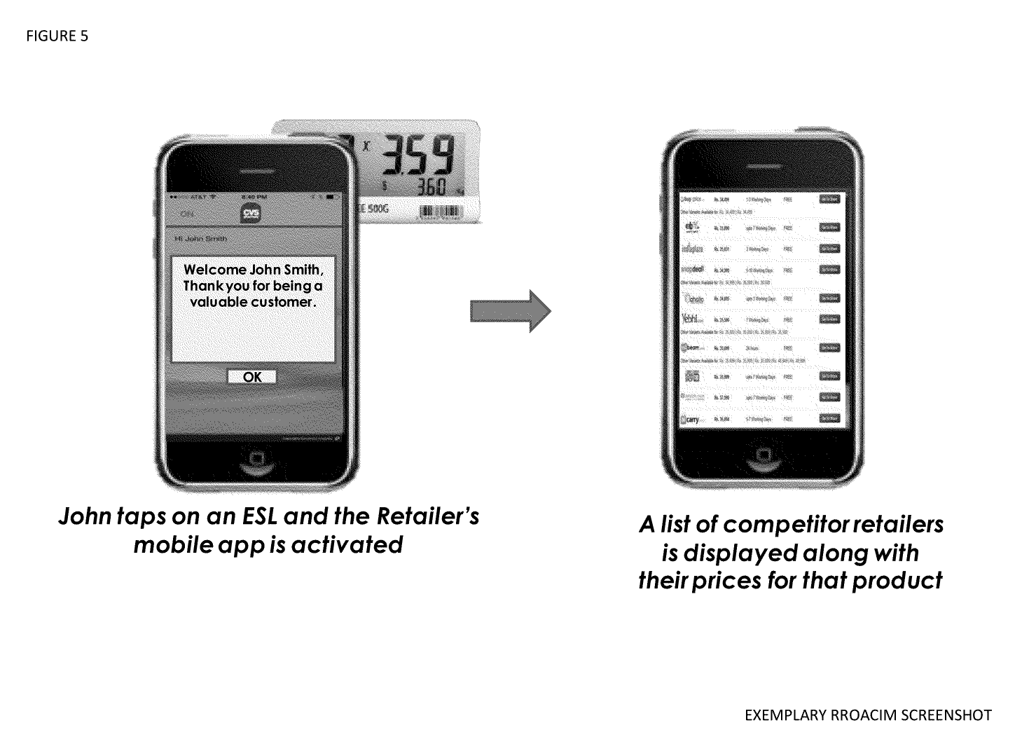

FIG. 5 shows a screenshot diagram illustrating embodiments of the RROACIM. In FIG. 5, a consumer, John, shopping at a retailer taps on an ESL associated with a product with the consumer's smartphone. In response, the retailer's mobile app may be automatically activated. Analysis of John's traffic patterns predicts that John is going to pass by a competing retailer on his way through a shopping mall. Accordingly, a price comparison of the product that includes the competing retailer may be shown to reassure John that the competing store does not have a better price.

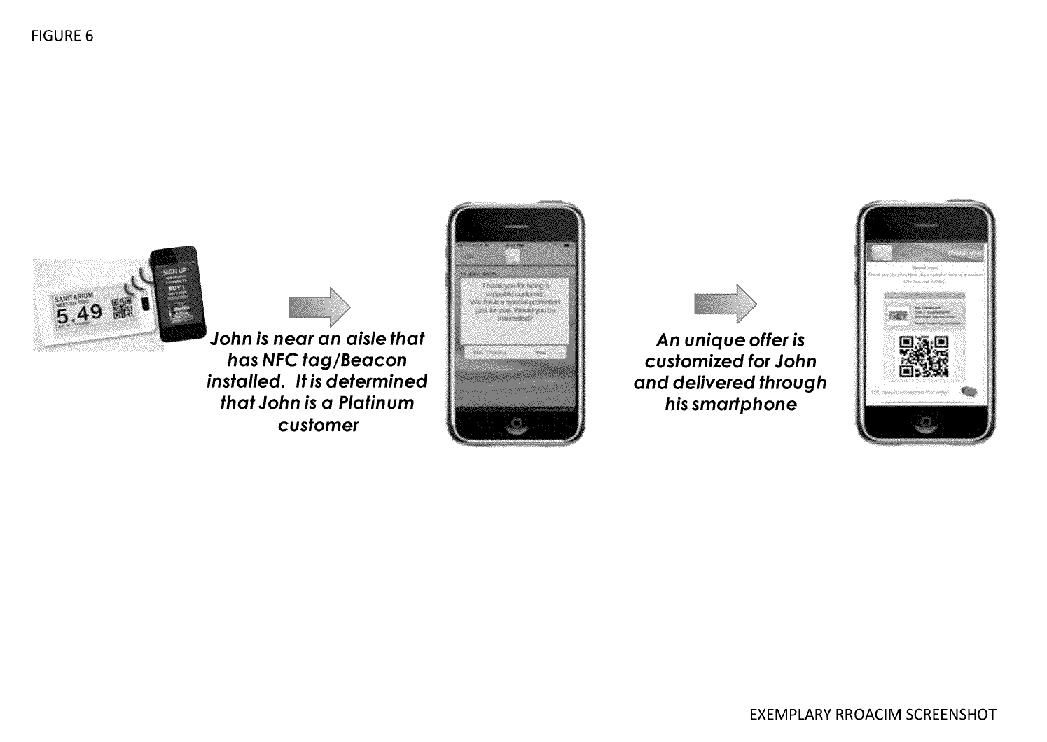

FIG. 6 shows a screenshot diagram illustrating embodiments of the RROACIM. In FIG. 6, the a consumer is near an aisle that has an installed beacon or the consumer has tapped on an NFC tag in that aisle or has scanned a unique QR/bar code in that aisle. The consumer's beacon data indicates that the consumer is John, a platinum customer. Accordingly, a unique offer tailored to platinum customers is customized for John, and, if John indicates that he wishes to take advantage of the offer, a coupon (e.g., in the form of a QR code) may be delivered to his smartphone.

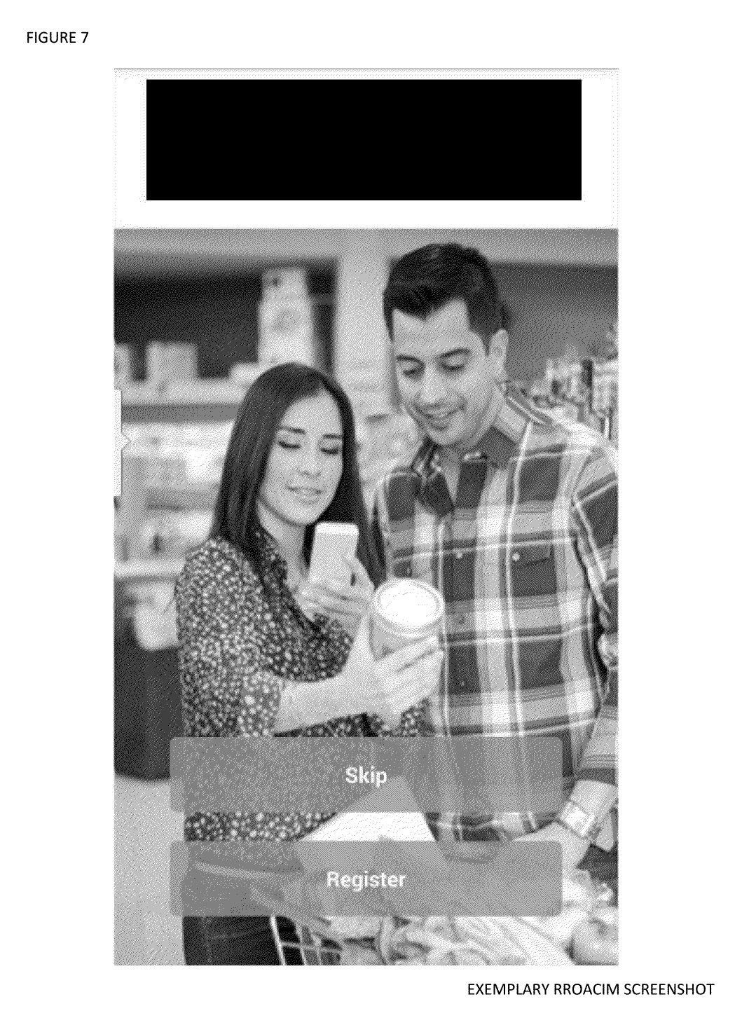

FIG. 7 shows a screenshot diagram illustrating embodiments of the RROACIM. In FIG. 7, an exemplary mobile app of a retailer is shown. The mobile app may be utilized by a consumer of the retailer. The consumer may choose to register and/or log into the mobile app or skip registration and use the mobile app anonymously.

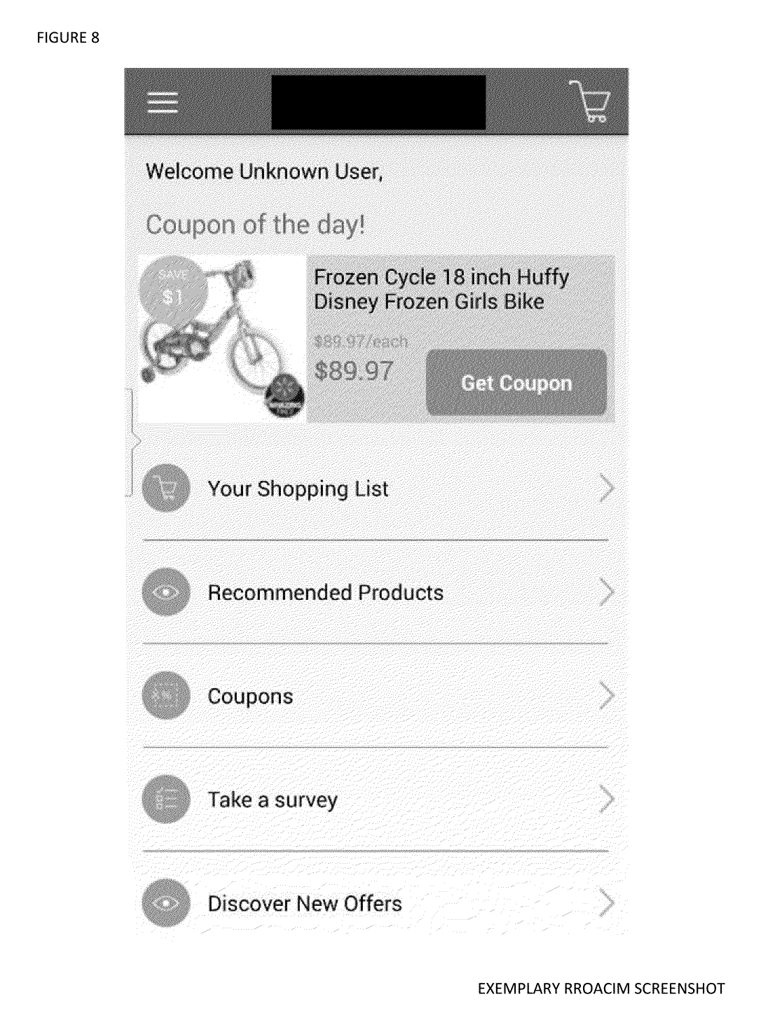

FIG. 8 shows a screenshot diagram illustrating embodiments of the RROACIM. In FIG. 8, the consumer chooses to skip registration. Accordingly, a coupon (e.g., a coupon of the day) may be shown to the consumer that is based on analysis of beacon and/or video data associated with the consumer. The consumer may tap the Get Coupon button to obtain the coupon.

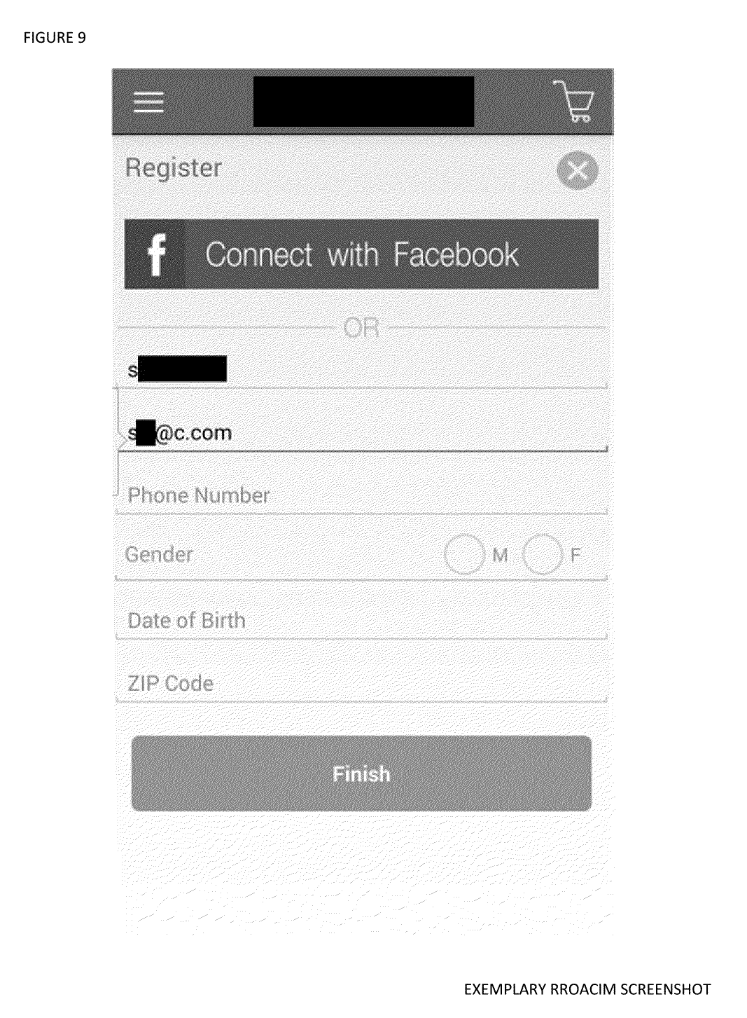

FIG. 9 shows a screenshot diagram illustrating embodiments of the RROACIM. In FIG. 9, the consumer chooses to register. In one embodiment, the consumer may specify login information (e.g., username, email address, password) and/or profile data (e.g., gender, date of birth, zip code). In another embodiment, the consumer may use preexisting login credentials (e.g., using Facebook). In some implementations, additional profile data regarding the consumer may be obtained. For example, the consumer's email address may be utilized to obtain profile information from a third party source. In another example, a social network API (e.g., Facebook API) may be utilized to obtain profile information about the consumer.

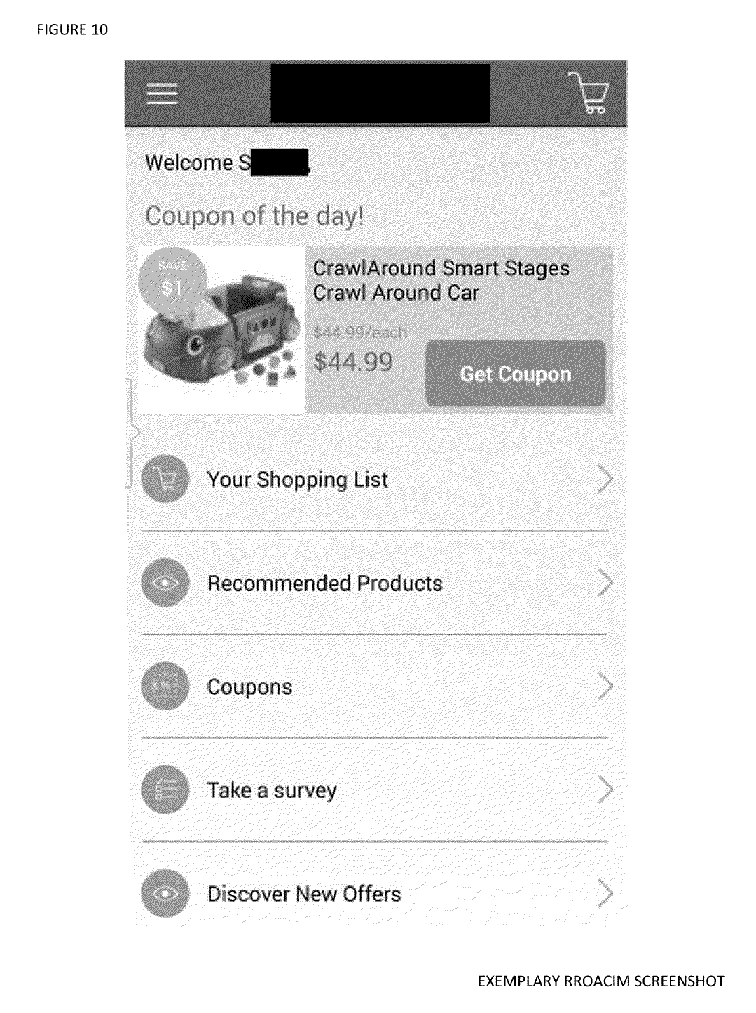

FIG. 10 shows a screenshot diagram illustrating embodiments of the RROACIM. In FIG. 10, a coupon (e.g., a coupon of the day) may be shown to the consumer that is based on analysis of video data and profile data associated with the consumer. The consumer may tap the Get Coupon button to obtain the coupon.

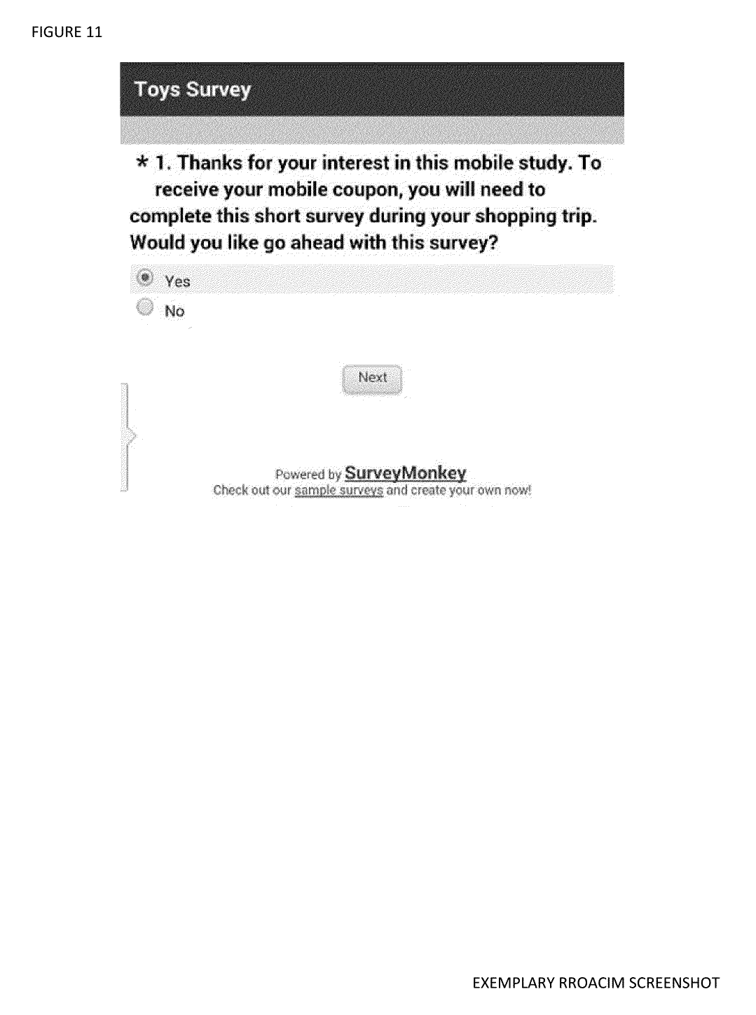

FIG. 11 shows a screenshot diagram illustrating embodiments of the RROACIM. In FIG. 11, after tapping on the Get Coupon button, the consumer may be prompted to take a short survey in order to get the coupon.

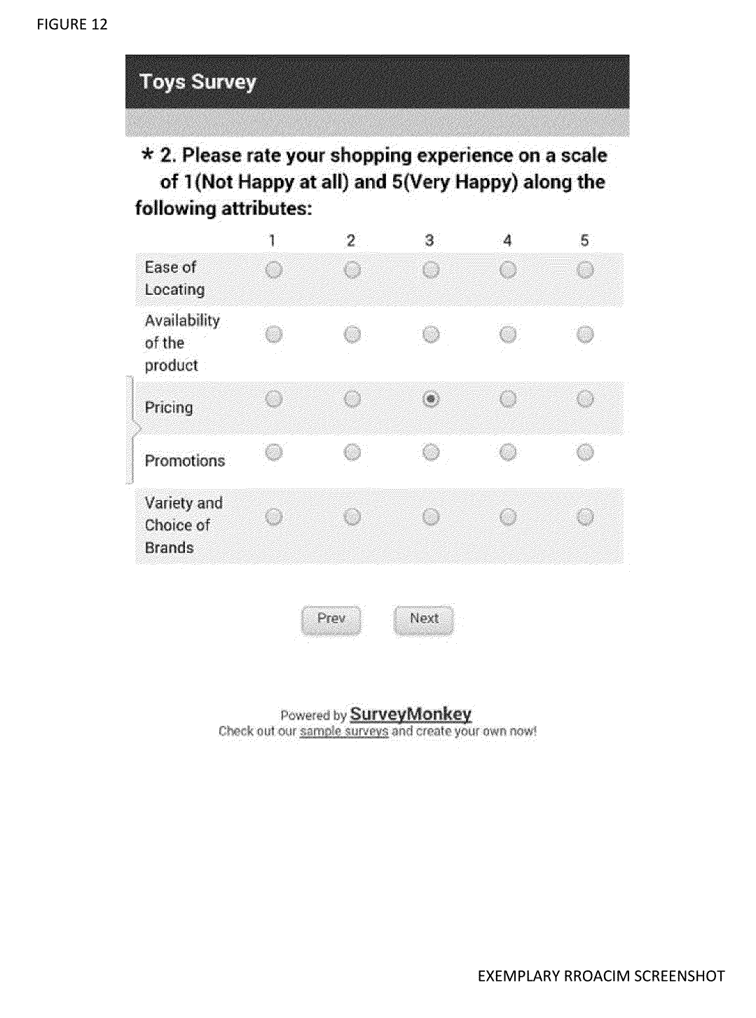

FIG. 12 shows a screenshot diagram illustrating embodiments of the RROACIM. In FIG. 12, the consumer chooses to take the survey and is presented with the survey. The consumer may fill out the survey using the consumer's mobile device (e.g., using a touch screen of the consumer's smartphone).

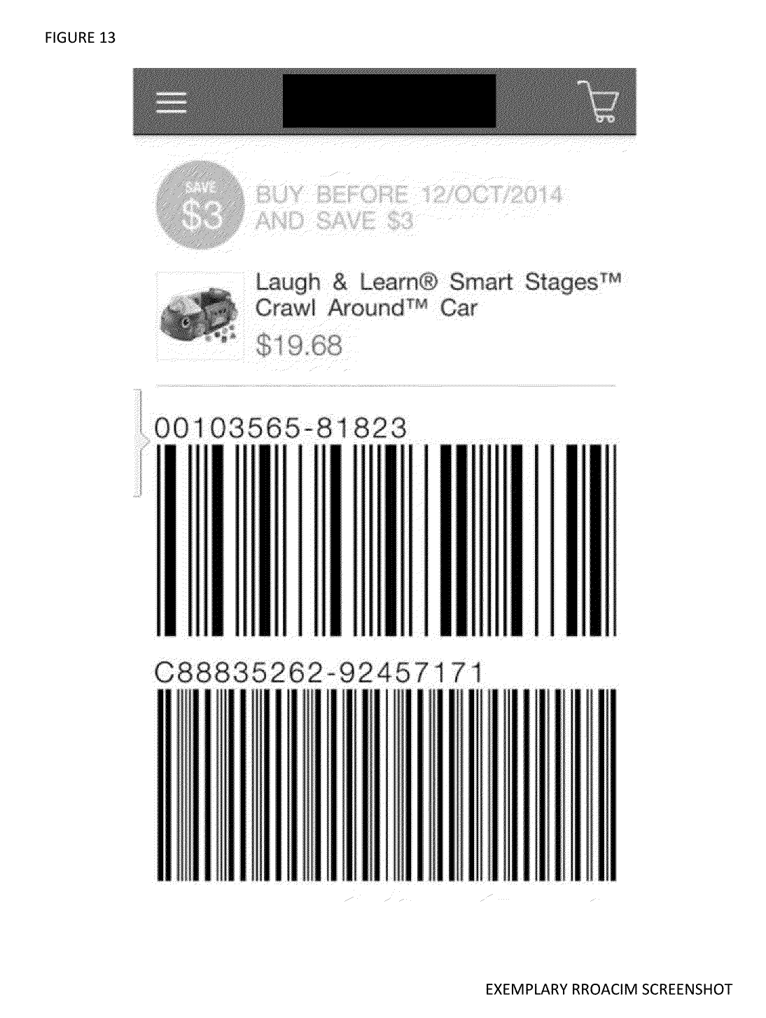

FIG. 13 shows a screenshot diagram illustrating embodiments of the RROACIM. In FIG. 13, the consumer receives one or more electronic coupons (e.g., in the form of barcodes). The consumer may present these electronic coupons at the register to receive discounts. For example, the consumer may receive a discount on a Laugh & Learn car.

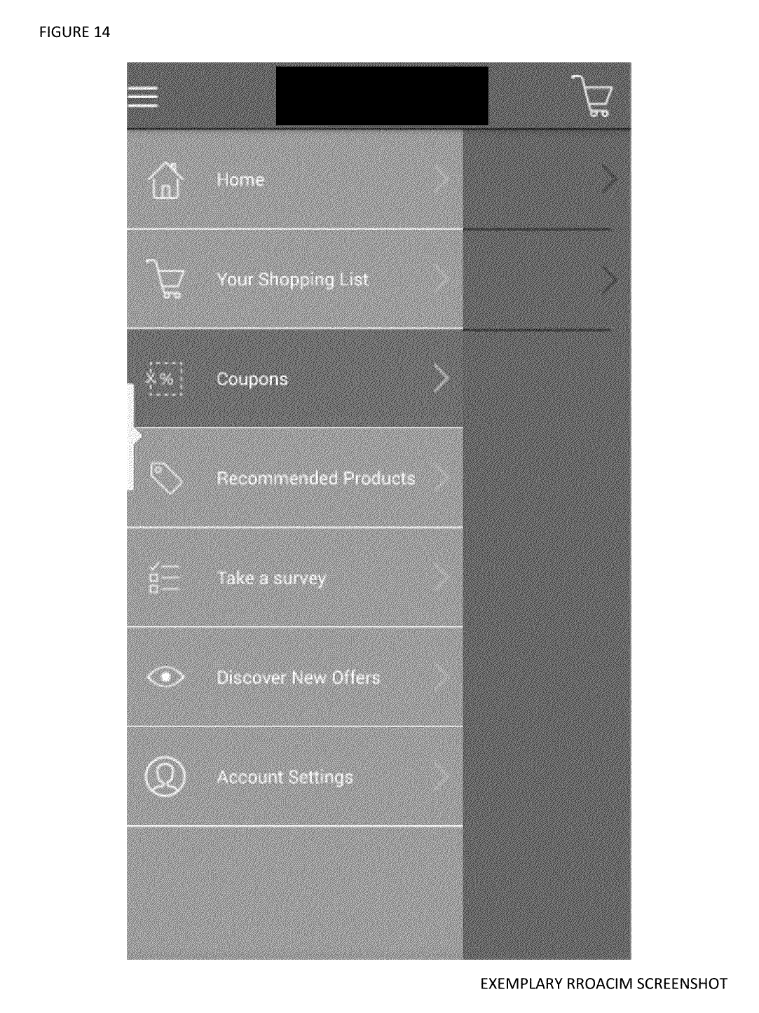

FIG. 14 shows a screenshot diagram illustrating embodiments of the RROACIM. In FIG. 14, the consumer may click on the Coupons menu option to see which coupons are available to the consumer.

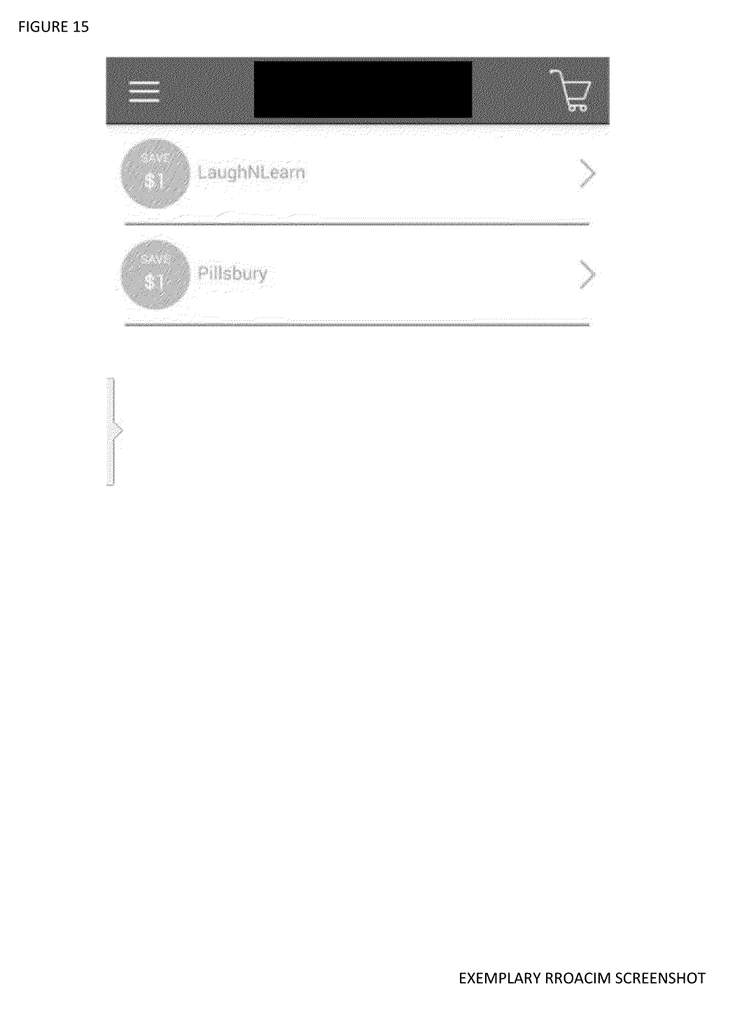

FIG. 15 shows a screenshot diagram illustrating embodiments of the RROACIM. In FIG. 15, coupons available to the consumer are shown, including the coupon for a discount on a Laugh & Learn car.

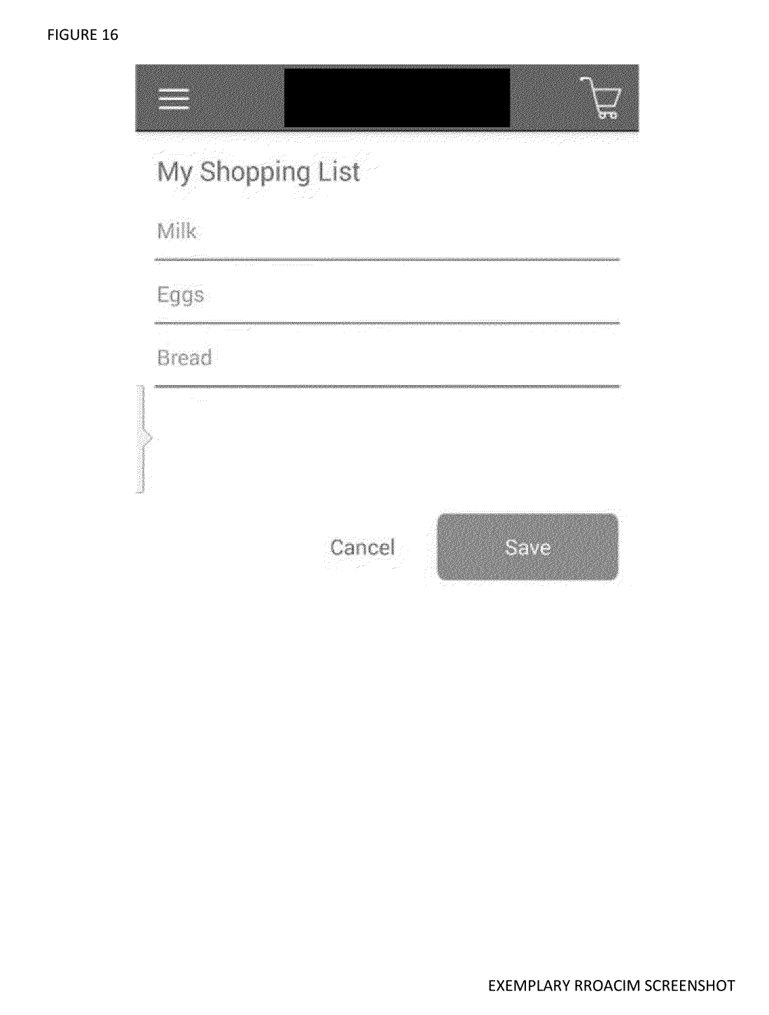

FIG. 16 shows a screenshot diagram illustrating embodiments of the RROACIM. In FIG. 16, the consumer may click on Your Shopping List menu option to display the consumer's shopping list. In some embodiments, the consumer's shopping list may be utilized when determining applicable offers for the consumer (e.g., discount codes, directions to products).

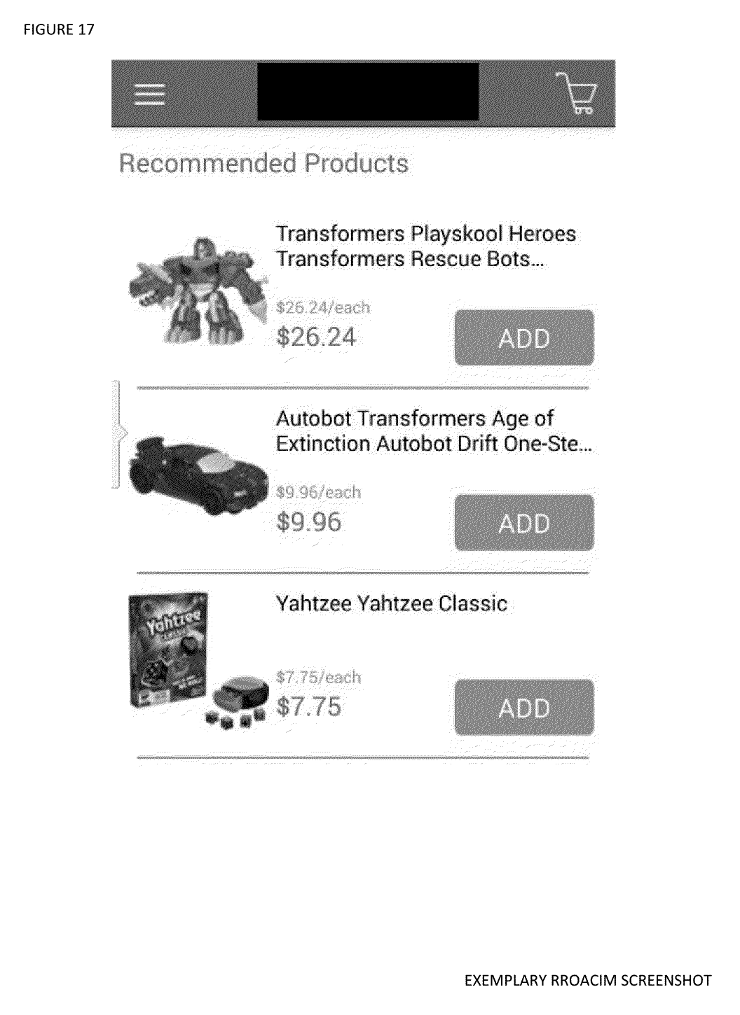

FIG. 17 shows a screenshot diagram illustrating embodiments of the RROACIM. In FIG. 17, recommended products for the consumer are shown. For example, analysis of video data and/or profile data associated with the consumer may indicate that the consumer is near a toys aisle and is likely to purchase toys. Accordingly, toys that are similar to toys previously purchased by the consumer may be recommended and displayed in a list on the screen of the consumer's smartphone. In some embodiments, the consumer may click the Add button associated with a product to purchase the product (e.g., the product may be delivered to the register when the consumer is ready to check out, the product may be mailed to the consumer's home).

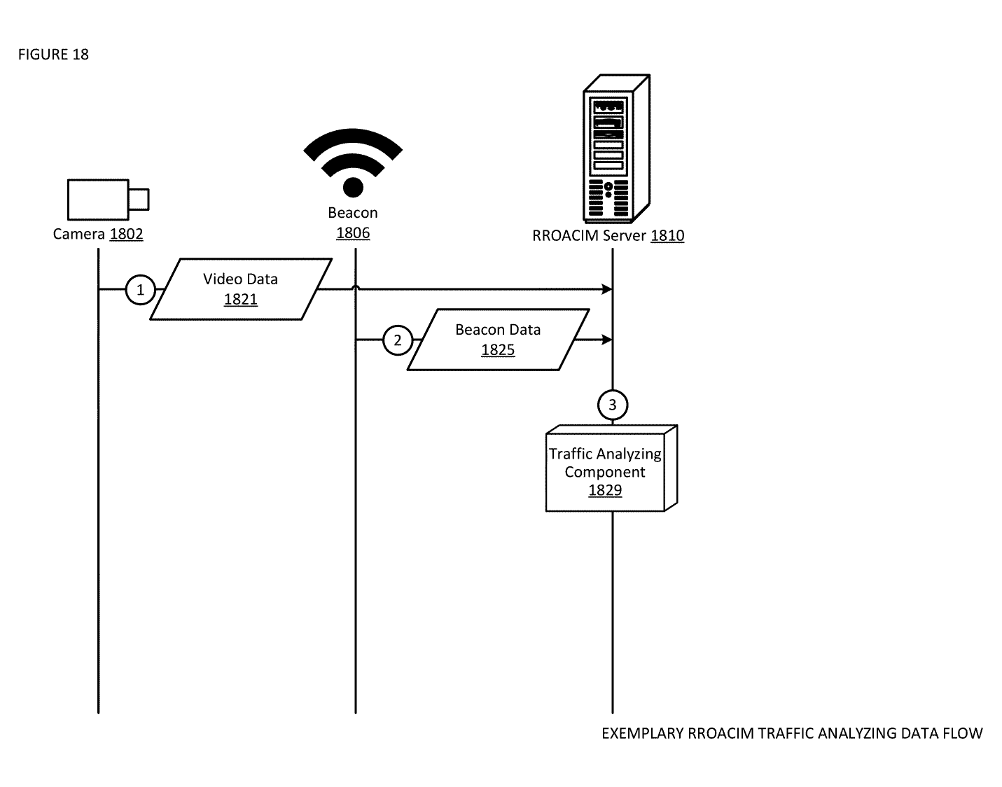

FIG. 18 shows a datagraph diagram illustrating embodiments of a traffic analyzing data flow for the RROACIM. In FIG. 18, a camera 1802 (e.g., one or more video cameras in a retail establishment) may send video data 1821 to a RROACIM server 1810. In one embodiment, the video data may show when consumers visit the retail establishment and/or how consumers pass through the retail establishment. In one implementation, video data may be sent as a video file (e.g., in AVI file format) or stream.

Beacon devices 1806 associated with consumer devices (e.g., tablets, smartphones) of consumers visiting the retail establishment may send beacon data 1825 to the RROACIM server. For example, Beacon devices may send beacon data as consumers enter and/or pass through the retail establishment (e.g., beacon data may be sent each time the consumer passes near each of the retailer's Bluetooth low energy beacons). In one implementation, beacon data may include a consumer device identifier, a Beacon device identifier, a consumer identifier, location data, physiological data, consumer preference data, and/or the like. For example, a Beacon device may provide the following example beacon data, substantially in the form of a HTTP(S) POST message including XML-formatted data, as provided below:

```
POST /beacon_data.php HTTP/1.1
Host: www.server.com
Content-Type: Application/XML
Content-Length: 667
<?XML version = “1.0” encoding = “UTF-8”?>
<beacon_data>
    <consumer_device_identifier>UUID of the device
    </consumer_device_identifier>
    <consumer_identifier>ID_Consumer1</consumer_identifier>
    <location>location data</location>
</beacon_data>
```

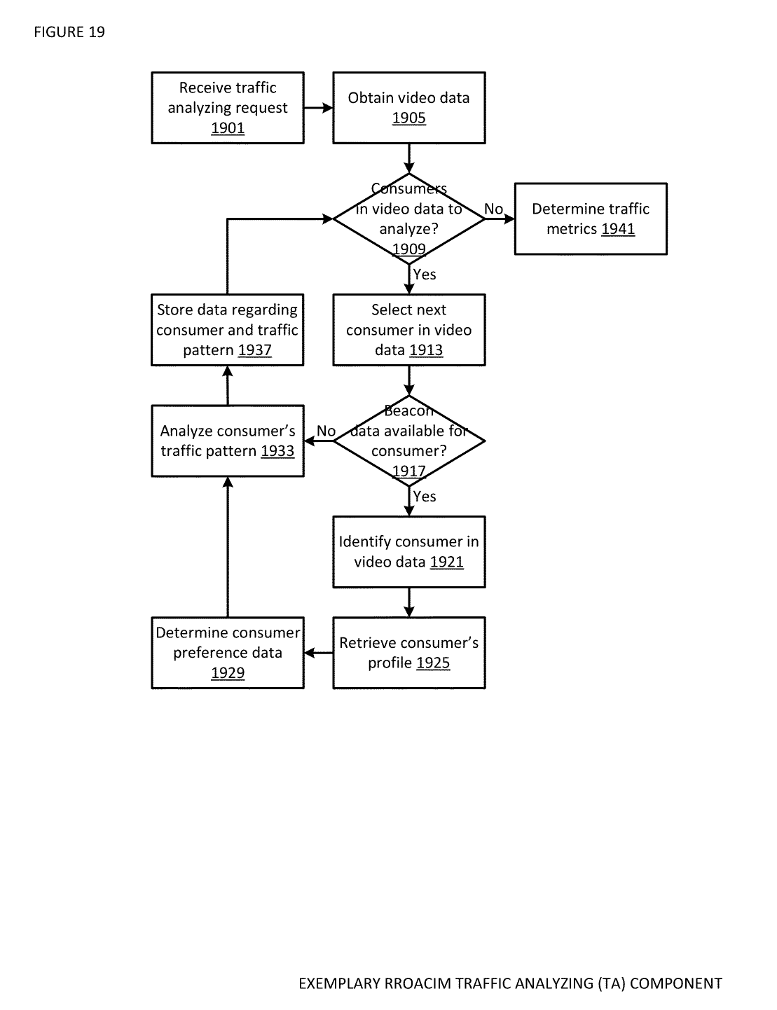

The RROACIM server may analyze video data, beacon data, consumer profile data, and/or the like using a traffic analyzing (TA) component 1829 to determine traffic metrics associated with the retail establishment. In one embodiment, traffic metrics may be utilized (e.g., by the OD component) to determine applicable offers. See FIG. 19 for additional details regarding the TA component.

FIG. 19 shows a logic flow diagram illustrating embodiments of a traffic analyzing (TA) component for the RROACIM. In FIG. 19, a traffic analyzing request may be received at 1901. For example, the traffic analyzing request may be received when a user (e.g., a RROACIM administrator) initiates traffic analysis for a retail establishment to determine traffic metrics associated with the retail establishment.

Video data associated with the retail establishment may be obtained at 1905. In one embodiment, real-time video data may be obtained from one or more cameras recording video data of the retail establishment. In another embodiment, one or more video files (e.g., having video data for a specified time period for which traffic analysis should be performed) associated with the retail establishment may be retrieved.

A determination may be made at 1909 whether there remain consumers in the obtained video data to analyze. In one embodiment, each of the consumers found in the video data may be analyzed. In another embodiment, consumers found in the video data for whom beacon data is also available may be analyzed. If there remain consumers to analyze, the next consumer found in the video data may be selected at 1913. In one embodiment, the video data may be analyzed to determine frame models of consumers. For example, each frame model may be analyzed in chronological order of appearance in the video data. In another example, multiple frame models may be tracked and analyzed simultaneously. In some implementations, frame models may be analyzed to classify consumers (e.g., single vs. couple, adult vs. child).

A determination may be made at 1917 whether beacon data is available for the selected consumer. In one embodiment, beacon data collected during the time corresponding to the time of the analysis and originating from the approximate location of the frame model of the selected consumer may be analyzed to determine whether there is a correspondence between beacon data from a consumer device and the frame model of the selected consumer. For example, this correspondence may be based by comparing location and/or movement patterns of the consumer device and the frame model. In another example, a candidate consumer identifier for the frame model may be determined and the associated profile data (e.g., demographic information, physical description) may be compared to the frame model to determine whether they correspond.

If it is determined that beacon data is available, the selected consumer in the video data may be identified at 1921. In one embodiment, an identifier (e.g., a consumer device identifier, a Beacon device identifier, a consumer identifier) associated with the corresponding beacon data may be determined and associated with the selected consumer. For example, it may be determined that the selected consumer should be associated with the consumer identifier ID_Consumer2. Consumer profile associated with the identifier may be retrieved at 1925, and consumer preference data and/or other profile data utilized to determine traffic metrics may be determined at 1929. For example, demographic information associated with the consumer may be determined. In another example, product preferences associated with the consumer may be determined. In one implementation, consumer preference data may be determined via a MySQL database command similar to the following:

SELECT consumerPreferenceData
FROM ConsumerAccounts
WHERE consumerID=“ID_Consumer2”;

The consumer's traffic pattern may be analyzed at 1933. In one embodiment, regions (e.g., stores in a shopping mall, aisles in a store) of the retail establishment visited by the consumer may be determined. In another embodiment, the path taken by the consumer to travel between regions may be determined. In yet another embodiment, dwell time (e.g., the time spent shopping in a store, the time spent waiting at a cash register) in various regions visited by the consumer may be determined. In one implementation, analysis of the consumer's traffic pattern may be based on information regarding when the consumer moves in and/or out of range of beacons in the retail establishment. For example, the path that the consumer took may be determined based on the order in which beacons were contacted. In another example, dwell time in a region may be determined based on the amount of time that passed between when the consumer moved in range and out of range of the beacon associated with the region.

The consumer's traffic pattern data and/or profile data utilized to determine traffic metrics may be stored at 1937. For example, traffic pattern data may be stored via a MySQL database command similar to the following:

INSERT INT0 TrafficPatterns (frameModelID,
correspondingConsumerID, frameModelTrafficPattern)
VALUES (ID_FrameModel1, ID_Consumer2, “consumer's traffic
pattern data”);

If consumers in the video data have been analyzed, traffic metrics for the retail establishment may be determined at 1941. In one embodiment, determining traffic metrics may include determining trends in customer traffic (e.g., growing, declining, steady) over time. In another embodiment, determining traffic metrics may include determining direction of customer traffic over time. In yet another embodiment, determining traffic metrics may include determining average dwell time. In various implementations, traffic metrics may be broken down for one or more regions, for specified types of customers (e.g., single vs. couple, adult vs. child), for specified time periods (e.g., daily, weekly, monthly), and/or the like. For example, traffic metrics may be stored via a MySQL database command similar to the following:

INSERT INT0 RetailLocation (retailID, retailTrafficMetrics)
VALUES (ID_Retailer1, “retailer's traffic metrics”);

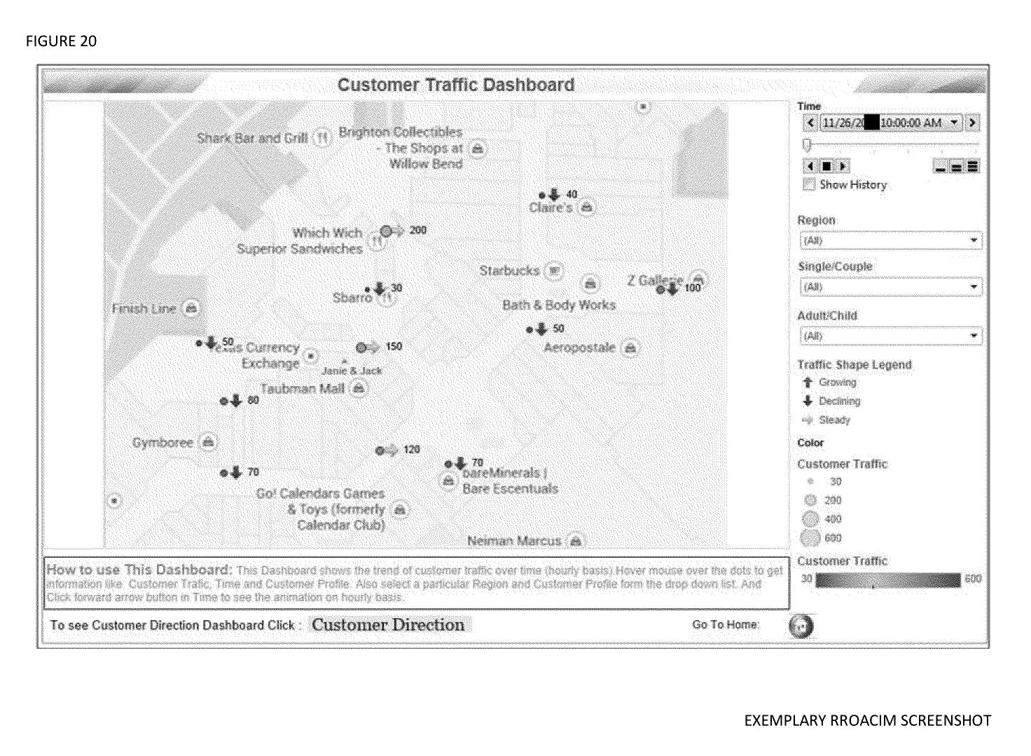

FIG. 20 shows a screenshot diagram illustrating embodiments of the RROACIM. In FIG. 20, a customer traffic dashboard shows trends of customer traffic over time (e.g., on an hourly basis). The information provided in the dashboard may be filtered by time, region, and customer type. This information may also be utilized (e.g., by the OD component) to determine applicable offers. For example, prices may be adjusted hourly based on anticipated traffic.

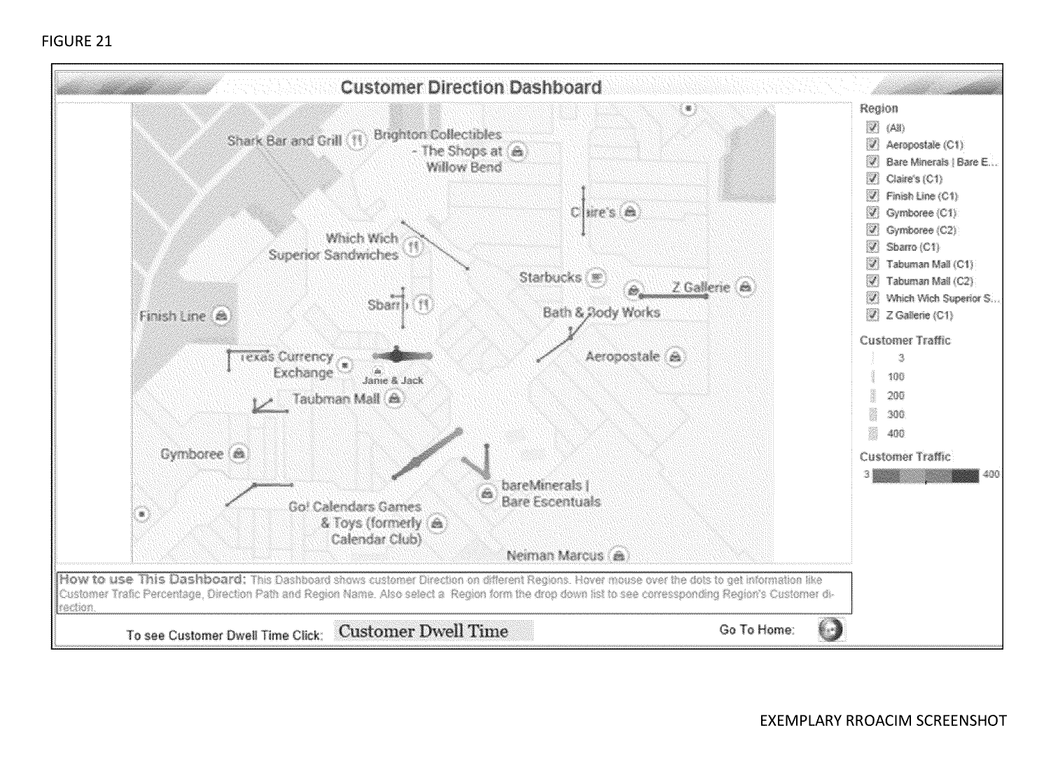

FIG. 21 shows a screenshot diagram illustrating embodiments of the RROACIM. In FIG. 21, a customer direction dashboard shows direction of travel for customers in different regions of a shopping mall (e.g., during the hour selected in the customer traffic dashboard). This information may also be utilized (e.g., by the OD component) to determine applicable offers. For example, an applicable offer for a consumer may include an offer from a store that is in the direction in which the consumer is likely to head.

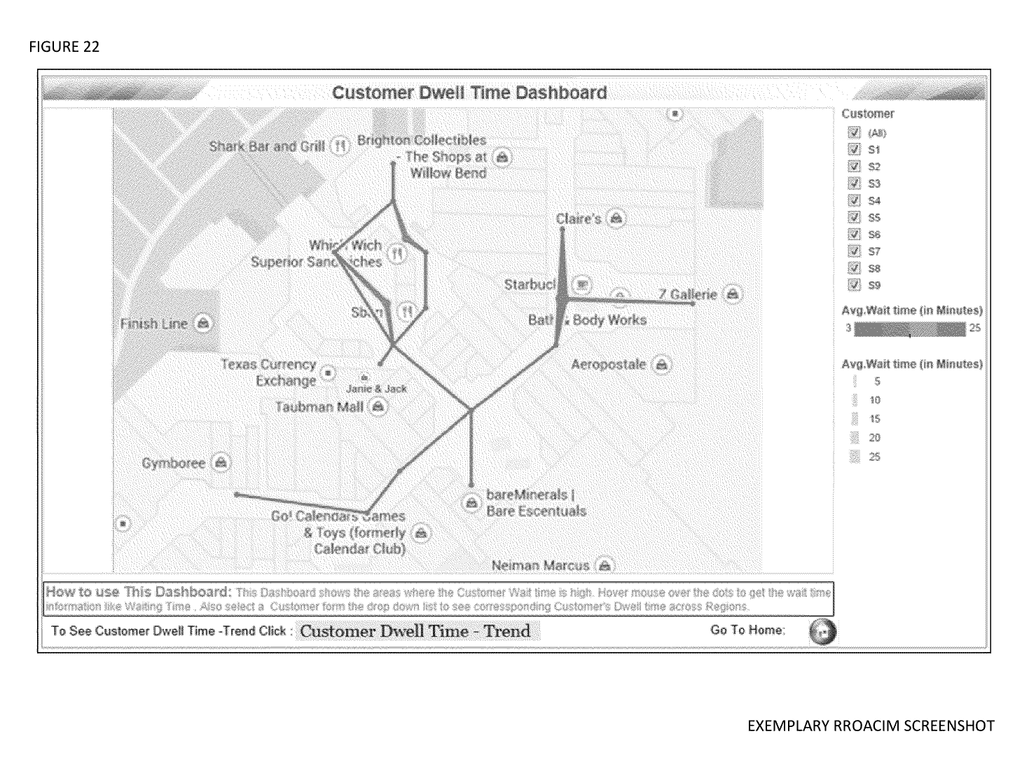

FIG. 22 shows a screenshot diagram illustrating embodiments of the RROACIM. In FIG. 22, a customer dwell time dashboard shows average wait time (e.g., in minutes) for individual customers in different regions. This information may also be utilized (e.g., by the OD component) to determine applicable offers. For example, an applicable offer for a consumer may be an offer to show directions that would facilitate buying items on the consumer's shopping list while encountering less wait time than the average for the customer.

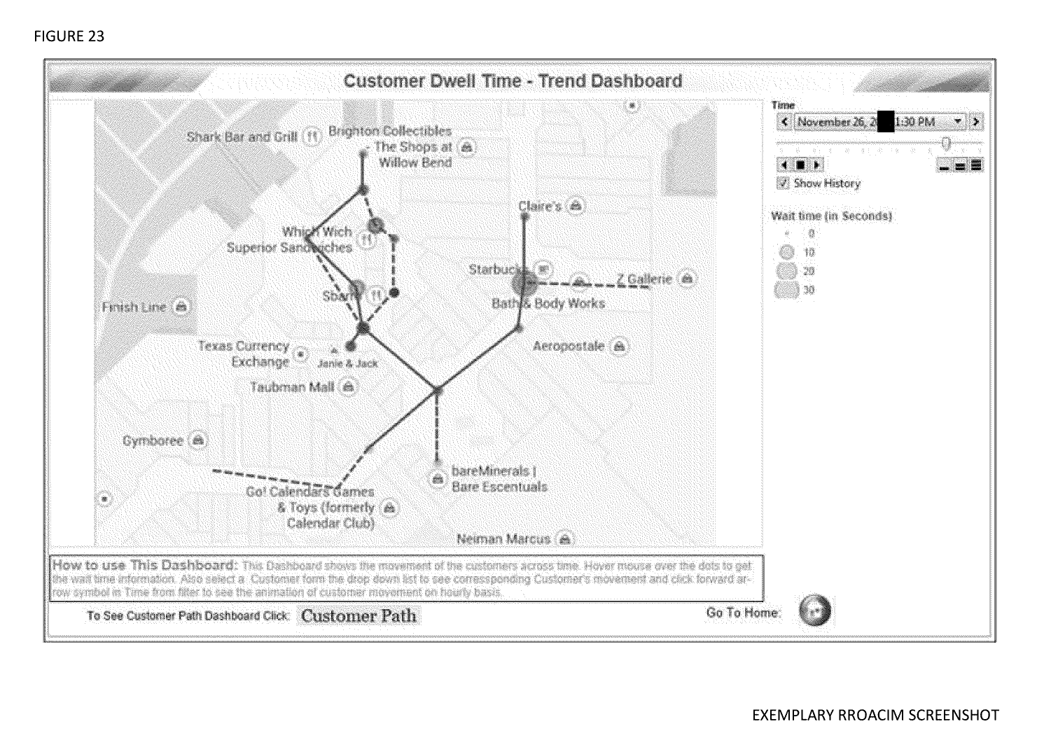

FIG. 23 shows a screenshot diagram illustrating embodiments of the RROACIM. In FIG. 23, a customer dwell time trend dashboard shows the movement of customers over time (e.g., on an hourly basis) and how long customers wait (e.g., in seconds) in different locations. This information may also be utilized (e.g., by the OD component) to determine applicable offers. For example, a restaurant that a couple typically passes by may wish to send a buy one entree get one free offer to the couple to encourage the couple to try out its food.

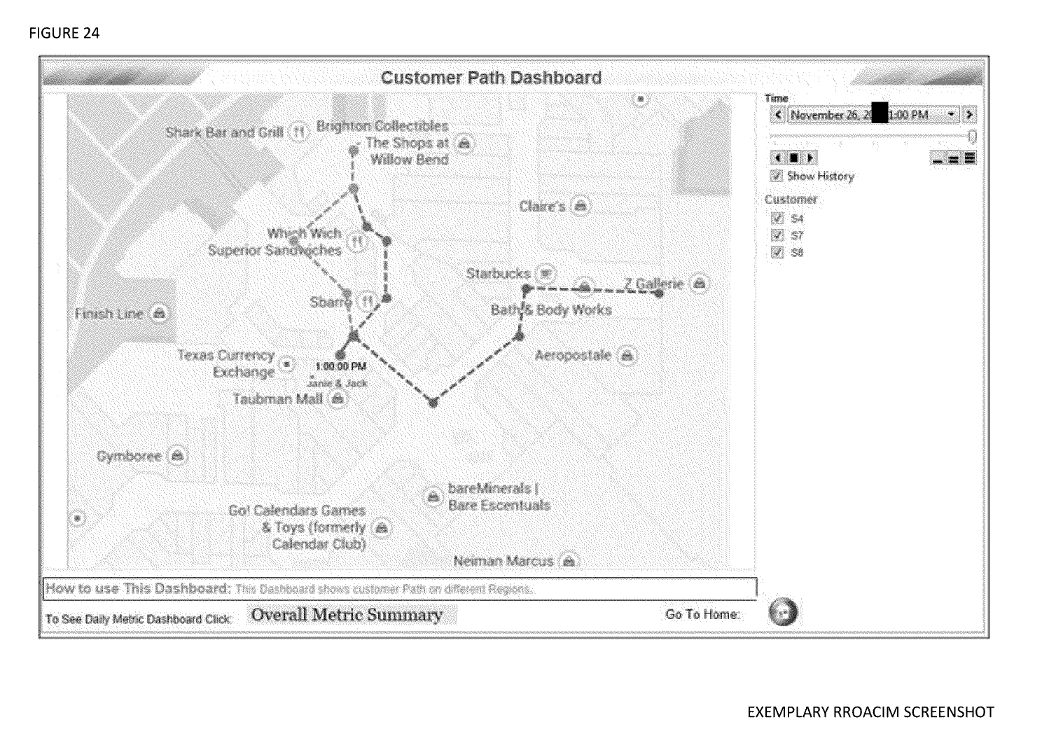

FIG. 24 shows a screenshot diagram illustrating embodiments of the RROACIM. In FIG. 24, a customer path dashboard shows paths taken by different customers to travel between different regions. This information may also be utilized (e.g., by the OD component) to determine applicable offers. For example, a store may wish to show a price comparison of a product of interest to a consumer to that of a competing store that the consumer typically passes to reassure the consumer that the competing store does not have a better price.

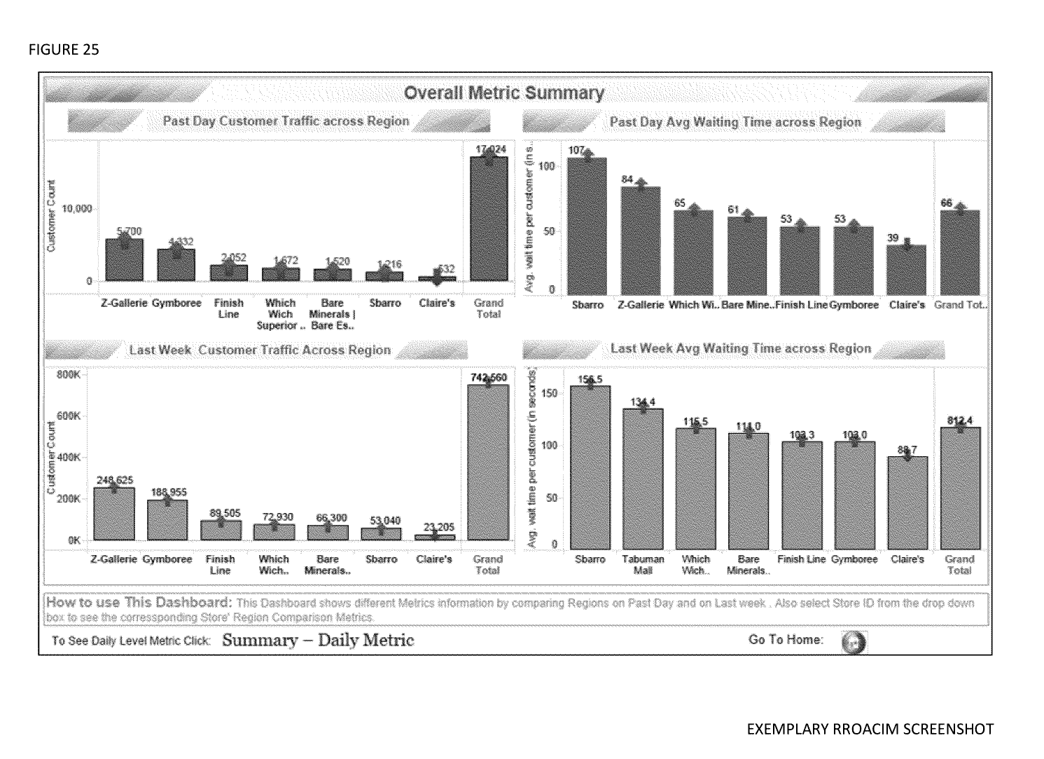

FIG. 25 shows a screenshot diagram illustrating embodiments of the RROACIM. In FIG. 25, an overall metric summary dashboard shows different metrics by comparing regions during the past day and during last week. This information may also be utilized (e.g., by the OD component) to determine applicable offers. For example, offers may be structured based on changes in metrics over time.

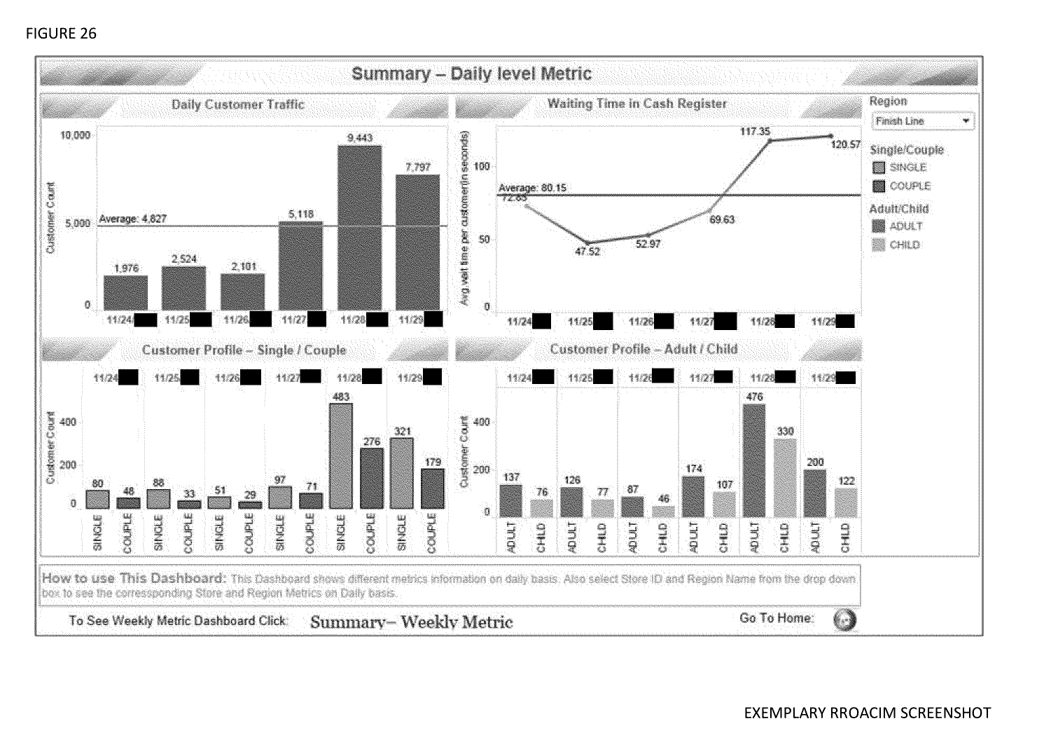

FIG. 26 shows a screenshot diagram illustrating embodiments of the RROACIM. In FIG. 26, a summary daily level metric dashboard shows different daily metrics for a selected region. This information may also be utilized (e.g., by the OD component) to determine applicable offers. For example, offers with higher discounts may be used during days when consumer traffic is lower.

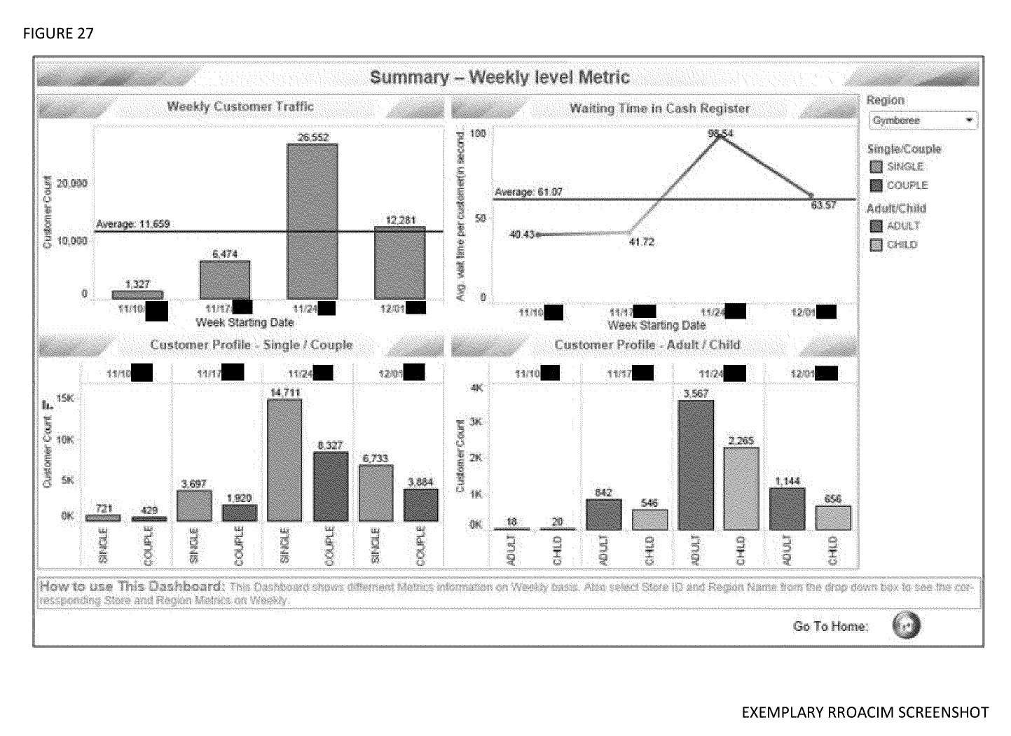

FIG. 27 shows a screenshot diagram illustrating embodiments of the RROACIM. In FIG. 27, a summary weekly level metric dashboard shows different weekly metrics for a selected region. This information may also be utilized (e.g., by the OD component) to determine applicable offers. For example, offers geared toward families with children may be used during weeks when more children are expected to visit.

### RROACIM Controller

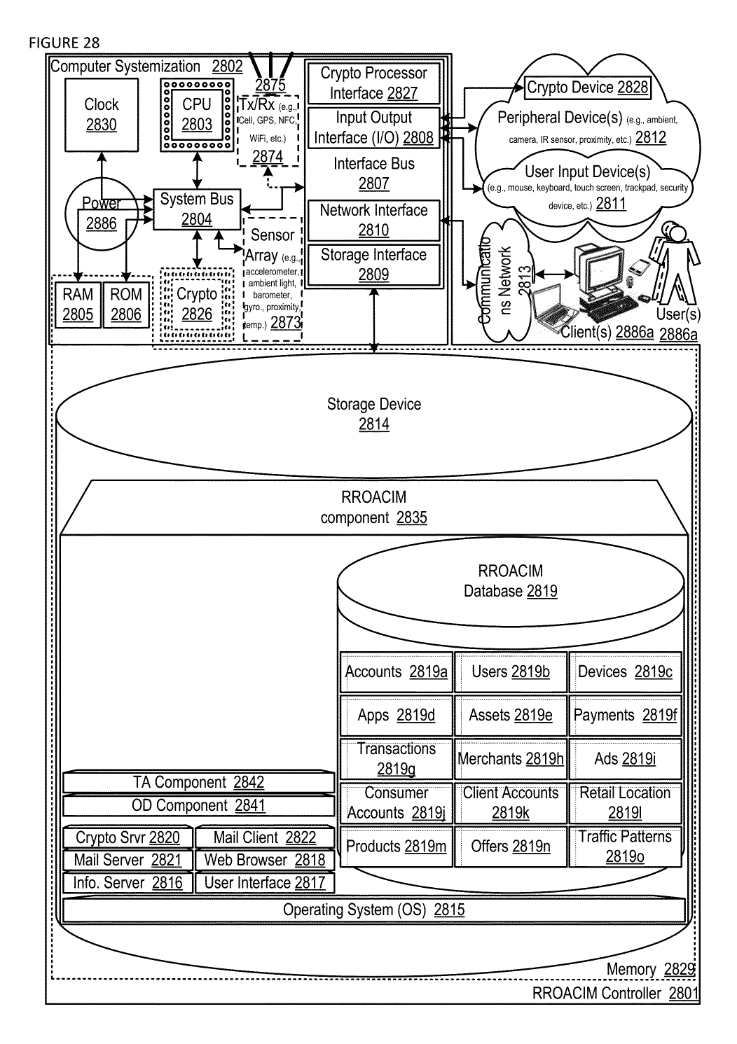

FIG. 28 shows a block diagram illustrating embodiments of a RROACIM controller. In this embodiment, the RROACIM controller 2801 may serve to aggregate, process, store, search, serve, identify, instruct, generate, match, and/or facilitate interactions with a computer through proximity and video recognition technologies, and/or other related data.

Typically, users, which may be people and/or other systems, may engage information technology systems (e.g., computers) to facilitate information processing. In turn, computers employ processors to process information; such processors 2803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the RROACIM controller 2801 may be connected to and/or communicate with entities such as, but not limited to: one or more users from peripheral devices 2812 (e.g., user input devices 2811); an optional cryptographic processor device 2828; and/or a communications network 2813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The RROACIM controller 2801 may be based on computer systems that may comprise, but are not limited to, components such as: a computer systemization 2802 connected to memory 2829.

### Computer Systemization

A computer systemization 2802 may comprise a clock 2830, central processing unit (“CPU(s)” and/or “processor(s)” (these terms are used interchangeable throughout the disclosure unless noted to the contrary)) 2803, a memory 2829 (e.g., a read only memory (ROM) 2806, a random access memory (RAM) 2805, etc.), and/or an interface bus 2807, and most frequently, although not necessarily, are all interconnected and/or communicating through a system bus 2804 on one or more (mother)board(s) 2802 having conductive and/or otherwise transportive circuit pathways through which instructions (e.g., binary encoded signals) may travel to effectuate communications, operations, storage, etc. The computer systemization may be connected to a power source 2886; e.g., optionally the power source may be internal. Optionally, a cryptographic processor 2826 may be connected to the system bus. In another embodiment, the cryptographic processor, transceivers (e.g., ICs) 2874, and/or sensor array (e.g., accelerometer, altimeter, ambient light, barometer, global positioning system (GPS) (thereby allowing RROACIM controller to determine its location), gyroscope, magnetometer, pedometer, proximity, ultra-violet sensor, etc.) 2873 may be connected as either internal and/or external peripheral devices 2812 via the interface bus I/O 2808 (not pictured) and/or directly via the interface bus 2807. In turn, the transceivers may be connected to antenna(s) 2875, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4752 GPS receiver with accelerometer, altimeter, GPS, gyroscope, magnetometer; a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom BCM43341 transceiver chip (e.g., providing 2G, 3G and 4G LTE cellular communications; 802.11 g/, Bluetooth 4.0, near field communication (NFC), FM radio); an Infineon Technologies X-Gold 618-PMB9800 transceiver chip (e.g., providing 2G/3G HSDPA/HSUPA communications); a MediaTek MT6620 transceiver chip (e.g., providing 802.11a/ac/b/g/n, Bluetooth 4.0 LE, FM, GPS; a Lapis Semiconductor ML8511 UV sensor; a maxim integrated MAX44000 ambient light and infrared proximity sensor; a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks), netbooks, tablets (e.g., Android, iPads, and Windows tablets, etc.), mobile smartphones (e.g., Android, iPhones, Nokia, Palm and Windows phones, etc.), wearable device(s) (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, A8, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the RROACIM controller and beyond through various interfaces. Should processing requirements dictate a greater amount speed and/or capacity, distributed processors (e.g., see Distributed RROACIM below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the RROACIM may be achieved by implementing a microcontroller such as CAST's R8051XC2 microcontroller; Intel's MCS 51 (i.e., 8051 microcontroller); and/or the like. Also, to implement certain features of the RROACIM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the RROACIM component collection (distributed or otherwise) and/or features may be implemented via the microprocessor and/or via embedded components; e.g., via ASIC, coprocessor, DSP, FPGA, and/or the like. Alternately, some implementations of the RROACIM may be implemented with embedded components that are configured and used to achieve a variety of features or signal processing.

Depending on the particular implementation, the embedded components may include software solutions, hardware solutions, and/or some combination of both hardware/software solutions. For example, RROACIM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the RROACIM features. A hierarchy of programmable interconnects allow logic blocks to be interconnected as needed by the RROACIM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the RROACIM may be developed on regular FPGAs and then migrated into a fixed version that more resembles ASIC implementations. Alternate or coordinating implementations may migrate RROACIM controller features to a final ASIC instead of or in addition to FPGAs. Depending on the implementation all of the aforementioned embedded components and microprocessors may be considered the “CPU” and/or “processor” for the RROACIM.

### Power Source

The power source 2886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2886 is connected to at least one of the interconnected subsequent components of the RROACIM thereby providing an electric current to all subsequent components. In one example, the power source 2886 is connected to the system bus component 2804. In an alternative embodiment, an outside power source 2886 is provided through a connection across the I/O 2808 interface. For example, a USB and/or IEEE 1394 connection carries both data and power across the connection and is therefore a suitable source of power.

### Interface Adapters

Interface bus(ses) 2807 may accept, connect, and/or communicate to a number of interface adapters, conventionally although not necessarily in the form of adapter cards, such as but not limited to: input output interfaces (I/O) 2808, storage interfaces 2809, network interfaces 2810, and/or the like. Optionally, cryptographic processor interfaces 2827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X), PCI Express, Personal Computer Memory Card International Association (PCMCIA), and/or the like.

Storage interfaces 2809 may accept, communicate, and/or connect to a number of storage devices such as, but not limited to: storage devices 2814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2810 may accept, communicate, and/or connect to a communications network 2813. Through a communications network 2813, the RROACIM controller is accessible through remote clients 2833b (e.g., computers with web browsers) by users 2833a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed RROACIM below), architectures may similarly be employed to pool, load balance, and/or otherwise decrease/increase the communicative bandwidth required by the RROACIM controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 2810 may be used to engage with various communications network types 2813. For example, multiple network interfaces may be employed to allow for the communication over broadcast, multicast, and/or unicast networks.

Input Output interfaces (I/O) 2808 may accept, communicate, and/or connect to user, peripheral devices 2812 (e.g., input devices 2811), cryptographic processor devices 2828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

Peripheral devices 2812 may be connected and/or communicate to I/O and/or other facilities of the like such as network interfaces, storage interfaces, directly to the interface bus, system bus, the CPU, and/or the like. Peripheral devices may be external, internal and/or part of the RROACIM controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 2811 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the RROACIM controller may be embodied as an embedded, dedicated, and/or monitor-less (i.e., headless) device, wherein access would be provided over a network interface connection.

Cryptographic units such as, but not limited to, microcontrollers, processors 2826, interfaces 2827, and/or devices 2828 may be attached, and/or communicate with the RROACIM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2829. However, memory is a fungible technology and resource, thus, any number of memory embodiments may be employed in lieu of or in concert with one another. It is to be understood that the RROACIM controller and/or a computer systemization may employ various forms of memory 2829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2829 will include ROM 2806, RAM 2805, and a storage device 2814. A storage device 2814 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 2829 may contain a collection of program and/or database components and/or data such as, but not limited to: operating system component(s) 2815 (operating system); information server component(s) 2816 (information server); user interface component(s) 2817 (user interface); Web browser component(s) 2818 (Web browser); database(s) 2819; mail server component(s) 2821; mail client component(s) 2822; cryptographic server component(s) 2820 (cryptographic server); the RROACIM component(s) 2835; and/or the like (i.e., collectively a component collection). These components may be stored and accessed from the storage devices and/or from storage devices accessible through an interface bus. Although non-conventional program components such as those in the component collection, typically, are stored in a local storage device 2814, they may also be loaded and/or stored in memory such as: peripheral devices, RAM, remote storage facilities through a communications network, ROM, various forms of memory, and/or the like.

### Operating System

The operating system component 2815 is an executable program component facilitating the operation of the RROACIM controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the RROACIM controller to communicate with other entities through a communications network 2813. Various communication protocols may be used by the RROACIM controller as a subcarrier transport mechanism for interaction, such as, but not limited to: multicast, TCP/IP, UDP, unicast, and/or the like.

### Information Server

An information server component 2816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the RROACIM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the RROACIM database 2819, operating systems, other program components, user interfaces, Web browsers, and/or the like.

Access to the RROACIM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the RROACIM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the RROACIM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome (e.g., and other webbrowser/cloud based client OSs); Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2818 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the RROACIM enabled nodes. The combined application may be nugatory on systems employing standard Web browsers.

### Mail Server

A mail server component 2821 is a stored program component that is executed by a CPU 2803. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the RROACIM. Alternatively, the mail server component may be distributed out to mail service providing entities such as Google's cloud services (e.g., Gmail and notifications may alternatively be provided via messenger services such as AOL's Instant Messenger, Apple's iMessage, Google Messenger, SnapChat, etc.).

Access to the RROACIM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2822 is a stored program component that is executed by a CPU 2803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2820 is a stored program component that is executed by a CPU 2803, cryptographic processor 2826, cryptographic processor interface 2827, cryptographic processor device 2828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the RROACIM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the RROACIM component to engage in secure transactions if so desired. The cryptographic component facilitates the secure accessing of resources on the RROACIM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The RROACIM Database

The RROACIM database component 2819 may be embodied in a database and its stored data. The database is a stored program component, which is executed by the CPU; the stored program component portion configuring the CPU to process the stored data. The database may be a conventional, fault tolerant, relational, scalable, secure database such as MySQL, Oracle, Sybase, etc. may be used. Additionally, optimized fast memory and distributed databases such as IBM's Netezza, MongoDB's MongoDB, opensource Hadoop, opensource VoltDB, SAP's Hana, etc. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the RROACIM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the RROACIM database is implemented as a data-structure, the use of the RROACIM database may be integrated into another component such as the RROACIM component 2835. Also, the database may be implemented as a mix of data structures, objects, and relational structures. Databases may be consolidated and/or distributed in countless variations (e.g., see Distributed RROACIM below). Portions of databases, e.g., tables, may be exported and/or imported and thus decentralized and/or integrated.

In one embodiment, the database component 2819 includes several tables 2819a-o:

An accounts table 2819a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table 2819b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a RROACIM);

An devices table 2819c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppinstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

An apps table 2819d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;

An assets table 2819e includes fields such as, but not limited to: assetID, accountID, userID, distributorAccountID, distributorPaymentID, distributorOnwerID, assetType, assetName, assetCode, assetQuantity, assetCost, assetPrice, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, and/or the like;

A payments table 2819f includes fields such as, but not limited to: paymentID, accountID, userID, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;

An transactions table 2819g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;

An merchants table 2819h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;

An ads table 2819i includes fields such as, but not limited to: adID, advertiserID, adNetworkTD, adName, adTags, advertiserName, adNetworkName, adNetworkAddress, adType (e.g., mobile, desktop, wearable, largescreen, interstitial, etc.), assetID, merchantID, deviceID, userID, accountID, and/or the like;

A consumer accounts table 2819j includes fields such as, but not limited to: a consumerID, consumerName, consumerAddress, consumerDevices, deviceIDs, paymentIDs, consumerProfileData, consumerPreferenceData, and/or the like (the consumer accounts table may support and/or track multiple entity accounts on a RROACIM);

A client accounts table 2819k includes fields such as, but not limited to: clientID, clientName, clientAddress, retailIDs, consumerIDs, and/or the like;

A retail location table 28191 includes fields such as, but not limited to: a retailID, retailAddress, retailGPS, retailFloorPlan, retailDeviceIDs, retailDevicePositions, retailTrafficMetrics, and/or the like;

A products table 2819m includes fields such as, but not limited to: a productID, clientID, retailID, productName, productType, productPrice, productQTY, productModelNo, and/or the like;

An offers table 2819n includes fields such as, but not limited to: offerID, offerDescription, retailID, productID, consumerTargetData, and/or the like;

A traffic patterns table 28190 includes fields such as, but not limited to: frameModelID, correspondingConsumerID, frameModelTrafficPattern, frameModelProfileData, analysisDateTime, and/or the like.

In one embodiment, the RROACIM database may interact with other database systems. For example, employing a distributed database system, queries and data access by search RROACIM component may treat the combination of the RROACIM database, an integrated data security layer database as a single database entity (e.g., see Distributed RROACIM below).

In one embodiment, user programs may contain various user interface primitives, which may serve to update the RROACIM. Also, various accounts may require custom database tables depending upon the environments and the types of clients the RROACIM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2819a-o. The RROACIM may be configured to keep track of various settings, inputs, and parameters via database controllers.

The RROACIM database may communicate to and/or with other components in a component collection, including itself, and/or facilities of the like. Most frequently, the RROACIM database communicates with the RROACIM component, other program components, and/or the like. The database may contain, retain, and provide information regarding other nodes and data.

### The RROACIMs

The RROACIM component 2835 is a stored program component that is executed by a CPU. In one embodiment, the RROACIM component incorporates any and/or all combinations of the aspects of the RROACIM that was discussed in the previous figures. As such, the RROACIM affects accessing, obtaining and the provision of information, services, transactions, and/or the like across various communications networks. The features and embodiments of the RROACIM discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the RROACIM's features and facilities, and in many cases reduce the costs, energy consumption/requirements, and extend the life of RROACIM's underlying infrastructure; this has the added benefit of making the RROACIM more reliable. Similarly, many of the features and mechanisms are designed to be easier for users to use and access, thereby broadening the audience that may enjoy/employ and exploit the feature sets of the RROACIM; such ease of use also helps to increase the reliability of the RROACIM. In addition, the feature sets include heightened security as noted via the Cryptographic components 2820, 2826, 2828 and throughout, making access to the features and data more reliable and secure

The RROACIM transforms offer determining request, traffic analyzing request, video data and Beacon data inputs, via RROACIM components (e.g., OD, TA), into applicable offer and traffic metrics outputs.

The RROACIM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the RROACIM server employs a cryptographic server to encrypt and decrypt communications. The RROACIM component may communicate to and/or with other components in a component collection, including itself, and/or facilities of the like. Most frequently, the RROACIM component communicates with the RROACIM database, operating systems, other program components, and/or the like. The RROACIM may contain, communicate, generate, obtain, and/or provide program component, system, user, and/or data communications, requests, and/or responses.

### Distributed RROACIMs

The structure and/or operation of any of the RROACIM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such a combination of hardware may be distributed within a location, within a region and/or globally where logical access to a controller may be abstracted as a singular node, yet where a multitude of private, semiprivate and publically accessible node controllers (e.g., via dispersed data centers) are coordinated to serve requests (e.g., providing private cloud, semiprivate cloud, and public cloud computing resources) and allowing for the serving of such requests in discrete regions (e.g., isolated, local, regional, national, global cloud access).

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the RROACIM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services, Microsoft Azure, Hewlett Packard Helion, IBM Cloud services allow for RROACIM controller and/or RROACIM component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the RROACIM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = “ ”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INT0 UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

Additional embodiments may include:
1. A realtime realworld and device correlating apparatus, comprising:
a memory;
a component collection in the memory, including:
   an offer determining component;
a processor disposed in communication with the memory, and configured to issue a plurality of processing instructions from the component collection stored in the memory,
   wherein the processor issues instructions from the offer determining component, stored in the memory, to:
      obtain, via processor, beacon data from a consumer device of a consumer entering in proximity to a retail establishment;
      retrieve, via processor, consumer profile information of the consumer;
      determine, via processor, an approximate consumer and consumer device location from the beacon data;
      obtain, via processor, realtime video feed targeted at the approximate consumer and consumer device location;
      generate, via processor, frame models of consumers in the targeted location from the obtained realtime video feed;
      determine, via processor, which frame model is of the consumer by correlating the beacon data and the consumer profile information with movements and descriptions of frame models;
      correlate, via processor, movements of the frame model with the consumer and consumer device;
      determine, via processor, intentionality of the consumer; and
      generate, via processor, an applicable offer for the consumer.
2. The apparatus of embodiment 1, wherein the beacon data includes a device identifier of the consumer device.
3. The apparatus of embodiment 1, wherein the beacon data includes location data associated with the consumer device.
4. The apparatus of embodiment 1, wherein the beacon data includes physiological data from a wearable device associated with the consumer.
5. The apparatus of embodiment 2, wherein instructions to retrieve consumer profile information of the consumer further comprise instructions to:
   determine a consumer identifier of the consumer based on the device identifier of the consumer device; and
   retrieve consumer profile information associated with the consumer identifier.
6. The apparatus of embodiment 1, wherein the consumer profile information includes demographic information associated with the consumer.
7. The apparatus of embodiment 1, wherein the consumer profile information includes consumer preference information associated with the consumer.
8. The apparatus of embodiment 3, wherein instructions to determine an approximate consumer and consumer device location from the beacon data further comprise instructions to determine geographic coordinates from GPS data included in the location data.
9. The apparatus of embodiment 1, wherein instructions to determine an approximate consumer and consumer device location from the beacon data further comprise instructions to determine the location of a beacon in communication range of the consumer device.
10. The apparatus of embodiment 9, wherein instructions to determine an approximate consumer and consumer device location from the beacon data further comprise instructions to determine signal strength between the beacon and the consumer device.
11. The apparatus of embodiment 1, wherein the realtime video feed comprises a plurality of simultaneous video feeds from a plurality of cameras.
12. The apparatus of embodiment 1, wherein instructions to determine which frame model is of the consumer further comprise instructions to:
   classify a generated frame model according to type; and
   determine whether the type associated with the generated frame model corresponds to the type specified in the consumer profile information of the consumer.
13. The apparatus of embodiment 1, wherein instructions to determine intentionality of the consumer further comprise instructions to predict whether the consumer is interested in purchasing a product.
14. The apparatus of embodiment 1, wherein instructions to determine intentionality of the consumer further comprise instructions to predict whether the consumer is unable to
15. The apparatus of embodiment 13, wherein instructions to generate an applicable offer for the consumer further comprise instructions to provide an electronic coupon associated with the product to the consumer.
16. The apparatus of embodiment 14, wherein instructions to generate an applicable offer for the consumer further comprise instructions to provide directions to the product to the consumer.
17. The apparatus of embodiment 15, wherein the electronic coupon is provided upon fulfillment of a condition by the consumer.
18. The apparatus of embodiment 17, wherein the condition is completion of a survey.
19. The apparatus of embodiment 1, further comprising:
   the processor issues instructions from the offer determining component, stored in the memory, to:
      generate a shelf tag update message for comparative information to be displayed to the consumer in proximity with a shelf tag targeted to receive the shelf tag update message.
20. The apparatus of embodiment 1, further comprising:
   the processor issues instructions from the offer determining component, stored in the memory, to:
      generate a shelf tag update message for offer information to be displayed to the consumer in proximity with a shelf tag targeted to receive the shelf tag update message.
21. A processor-readable realtime realworld and device correlating non-transient physical medium storing processor-executable components, the components, comprising:
a component collection stored in the medium, including:
   an offer determining component;
   wherein the offer determining component, stored in the medium, includes processor-issuable instructions to:
      obtain, via processor, beacon data from a consumer device of a consumer entering in proximity to a retail establishment;
      retrieve, via processor, consumer profile information of the consumer;
      determine, via processor, an approximate consumer and consumer device location from the beacon data;
      obtain, via processor, realtime video feed targeted at the approximate consumer and consumer device location;
      generate, via processor, frame models of consumers in the targeted location from the obtained realtime video feed;
      determine, via processor, which frame model is of the consumer by correlating the beacon data and the consumer profile information with movements and descriptions of frame models;
      correlate, via processor, movements of the frame model with the consumer and consumer device;
      determine, via processor, intentionality of the consumer; and
      generate, via processor, an applicable offer for the consumer.
22. The medium of embodiment 21, wherein the beacon data includes a device identifier of the consumer device.
23. The medium of embodiment 21, wherein the beacon data includes location data associated with the consumer device.
24. The medium of embodiment 21, wherein the beacon data includes physiological data from a wearable device associated with the consumer.
25. The medium of embodiment 22, wherein instructions to retrieve consumer profile information of the consumer further comprise instructions to:
   determine a consumer identifier of the consumer based on the device identifier of the consumer device; and
   retrieve consumer profile information associated with the consumer identifier.
26. The medium of embodiment 21, wherein the consumer profile information includes demographic information associated with the consumer.
27. The medium of embodiment 21, wherein the consumer profile information includes consumer preference information associated with the consumer.
28. The medium of embodiment 23, wherein instructions to determine an approximate consumer and consumer device location from the beacon data further comprise instructions to determine geographic coordinates from GPS data included in the location data.
29. The medium of embodiment 21, wherein instructions to determine an approximate consumer and consumer device location from the beacon data further comprise instructions to determine the location of a beacon in communication range of the consumer device.
30. The medium of embodiment 29, wherein instructions to determine an approximate consumer and consumer device location from the beacon data further comprise instructions to determine signal strength between the beacon and the consumer device.
31. The medium of embodiment 21, wherein the realtime video feed comprises a plurality of simultaneous video feeds from a plurality of cameras.
32. The medium of embodiment 21, wherein instructions to determine which frame model is of the consumer further comprise instructions to:
   classify a generated frame model according to type; and
   determine whether the type associated with the generated frame model corresponds to the type specified in the consumer profile information of the consumer.
33. The medium of embodiment 21, wherein instructions to determine intentionality of the consumer further comprise instructions to predict whether the consumer is interested in purchasing a product.
34. The medium of embodiment 21, wherein instructions to determine intentionality of the consumer further comprise instructions to predict whether the consumer is unable to find a product.
35. The medium of embodiment 33, wherein instructions to generate an applicable offer for the consumer further comprise instructions to provide an electronic coupon associated with the product to the consumer.
36. The medium of embodiment 34, wherein instructions to generate an applicable offer for the consumer further comprise instructions to provide directions to the product to the consumer.
37. The medium of embodiment 35, wherein the electronic coupon is provided upon fulfillment of a condition by the consumer.
38. The medium of embodiment 37, wherein the condition is completion of a survey.
39. The medium of embodiment 21, further, comprising:
   the offer determining component, stored in the medium, includes processor-issuable instructions to:
      generate a shelf tag update message for comparative information to be displayed to the consumer in proximity with a shelf tag targeted to receive the shelf tag update message.
40. The medium of embodiment 21, further, comprising:
   the offer determining component, stored in the medium, includes processor-issuable instructions to:
      generate a shelf tag update message for offer information to be displayed to the consumer in proximity with a shelf tag targeted to receive the shelf tag update message.
41. A processor-implemented realtime realworld and device correlating system, comprising:
   an offer determining component means, to:
      obtain, via processor, beacon data from a consumer device of a consumer entering in proximity to a retail establishment;
      retrieve, via processor, consumer profile information of the consumer;
      determine, via processor, an approximate consumer and consumer device location from the beacon data;
      obtain, via processor, realtime video feed targeted at the approximate consumer and consumer device location;
      generate, via processor, frame models of consumers in the targeted location from the obtained realtime video feed;
      determine, via processor, which frame model is of the consumer by correlating the beacon data and the consumer profile information with movements and descriptions of frame models;
      correlate, via processor, movements of the frame model with the consumer and consumer device;
      determine, via processor, intentionality of the consumer; and
      generate, via processor, an applicable offer for the consumer.
42. The system of embodiment 41, wherein the beacon data includes a device identifier of the consumer device.
43. The system of embodiment 41, wherein the beacon data includes location data associated with the consumer device.
44. The system of embodiment 41, wherein the beacon data includes physiological data from a wearable device associated with the consumer.
45. The system of embodiment 42, wherein means to retrieve consumer profile information of the consumer further comprise means to:
   determine a consumer identifier of the consumer based on the device identifier of the consumer device; and
   retrieve consumer profile information associated with the consumer identifier.
46. The system of embodiment 41, wherein the consumer profile information includes demographic information associated with the consumer.
47. The system of embodiment 41, wherein the consumer profile information includes consumer preference information associated with the consumer.
48. The system of embodiment 43, wherein means to determine an approximate consumer and consumer device location from the beacon data further comprise means to determine geographic coordinates from GPS data included in the location data.
49. The system of embodiment 41, wherein means to determine an approximate consumer and consumer device location from the beacon data further comprise means to determine the location of a beacon in communication range of the consumer device.
50. The system of embodiment 49, wherein means to determine an approximate consumer and consumer device location from the beacon data further comprise means to determine signal strength between the beacon and the consumer device.
51. The system of embodiment 41, wherein the realtime video feed comprises a plurality of simultaneous video feeds from a plurality of cameras.
52. The system of embodiment 41, wherein means to determine which frame model is of the consumer further comprise means to:
   classify a generated frame model according to type; and
   determine whether the type associated with the generated frame model corresponds to the type specified in the consumer profile information of the consumer.
53. The system of embodiment 41, wherein means to determine intentionality of the consumer further comprise means to predict whether the consumer is interested in purchasing a product.
54. The system of embodiment 41, wherein means to determine intentionality of the consumer further comprise means to predict whether the consumer is unable to find a product.
55. The system of embodiment 53, wherein means to generate an applicable offer for the consumer further comprise means to provide an electronic coupon associated with the product to the consumer.
56. The system of embodiment 54, wherein means to generate an applicable offer for the consumer further comprise means to provide directions to the product to the consumer.
57. The system of embodiment 55, wherein the electronic coupon is provided upon fulfillment of a condition by the consumer.
58. The system of embodiment 57, wherein the condition is completion of a survey.
59. The system of embodiment 41, further, comprising:
   the offer determining component means, to:
      generate a shelf tag update message for comparative information to be displayed to the consumer in proximity with a shelf tag targeted to receive the shelf tag update message.
60. The system of embodiment 41, further, comprising:
   the offer determining component means, to:
      generate a shelf tag update message for offer information to be displayed to the consumer in proximity with a shelf tag targeted to receive the shelf tag update message.
61. A processor-readable realtime realworld and device correlating method, comprising:
   executing processor-implemented offer determining component instructions to:
      obtain, via processor, beacon data from a consumer device of a consumer entering in proximity to a retail establishment;
      retrieve, via processor, consumer profile information of the consumer;
      determine, via processor, an approximate consumer and consumer device location from the beacon data;
      obtain, via processor, realtime video feed targeted at the approximate consumer and consumer device location;
      generate, via processor, frame models of consumers in the targeted location from the obtained realtime video feed;
      determine, via processor, which frame model is of the consumer by correlating the beacon data and the consumer profile information with movements and descriptions of frame models;
      correlate, via processor, movements of the frame model with the consumer and consumer device;
      determine, via processor, intentionality of the consumer; and
      generate, via processor, an applicable offer for the consumer.
62. The method of embodiment 61, wherein the beacon data includes a device identifier of the consumer device.
63. The method of embodiment 61, wherein the beacon data includes location data associated with the consumer device.
64. The method of embodiment 61, wherein the beacon data includes physiological data from a wearable device associated with the consumer.
65. The method of embodiment 62, wherein instructions to retrieve consumer profile information of the consumer further comprise instructions to:
   determine a consumer identifier of the consumer based on the device identifier of the consumer device; and
   retrieve consumer profile information associated with the consumer identifier.
66. The method of embodiment 61, wherein the consumer profile information includes demographic information associated with the consumer.
67. The method of embodiment 61, wherein the consumer profile information includes consumer preference information associated with the consumer.
68. The method of embodiment 63, wherein instructions to determine an approximate consumer and consumer device location from the beacon data further comprise instructions to determine geographic coordinates from GPS data included in the location data.
69. The method of embodiment 61, wherein instructions to determine an approximate consumer and consumer device location from the beacon data further comprise instructions to determine the location of a beacon in communication range of the consumer device.
70. The method of embodiment 69, wherein instructions to determine an approximate consumer and consumer device location from the beacon data further comprise instructions to determine signal strength between the beacon and the consumer device.
71. The method of embodiment 61, wherein the realtime video feed comprises a plurality of simultaneous video feeds from a plurality of cameras.
72. The method of embodiment 61, wherein instructions to determine which frame model is of the consumer further comprise instructions to:
   classify a generated frame model according to type; and
   determine whether the type associated with the generated frame model corresponds to the type specified in the consumer profile information of the consumer.
73. The method of embodiment 61, wherein instructions to determine intentionality of the consumer further comprise instructions to predict whether the consumer is interested in purchasing a product.
74. The method of embodiment 61, wherein instructions to determine intentionality of the consumer further comprise instructions to predict whether the consumer is unable to find a product.
75. The method of embodiment 73, wherein instructions to generate an applicable offer for the consumer further comprise instructions to provide an electronic coupon associated with the product to the consumer.
76. The method of embodiment 74, wherein instructions to generate an applicable offer for the consumer further comprise instructions to provide directions to the product to the consumer.
77. The method of embodiment 75, wherein the electronic coupon is provided upon fulfillment of a condition by the consumer.
78. The method of embodiment 77, wherein the condition is completion of a survey.
79. The method of embodiment 61, further, comprising:
   executing processor-implemented offer determining component instructions to:
      generate a shelf tag update message for comparative information to be displayed to the consumer in proximity with a shelf tag targeted to receive the shelf tag update message.
80. The method of embodiment 61, further, comprising:
   executing processor-implemented offer determining component instructions to:
      generate a shelf tag update message for offer information to be displayed to the consumer in proximity with a shelf tag targeted to receive the shelf tag update message.
81. The apparatus of embodiment 1, wherein the intentionality of the consumer is determined based on analysis of the beacon data and of the consumer profile information, and wherein analysis of the realtime video feed is utilized to confirm the determined intentionality of the consumer.
82. The apparatus of embodiment 1, further comprising:
   the processor issues instructions from the offer determining component, stored in the memory, to:
      send the applicable offer in a message.
83. The apparatus of embodiment 1, wherein the beacon data is obtained from the consumer device of the consumer who is entering in proximity to the retail establishment in a moving vehicle.
84. The medium of embodiment 21, wherein the intentionality of the consumer is determined based on analysis of the beacon data and of the consumer profile information, and wherein analysis of the realtime video feed is utilized to confirm the determined intentionality of the consumer.
85. The medium of embodiment 21, further comprising:
   the offer determining component, stored in the medium, includes processor-issuable instructions to:
      send the applicable offer in a message.
86. The medium of embodiment 21, wherein the beacon data is obtained from the consumer device of the consumer who is entering in proximity to the retail establishment in a moving vehicle.
87. The system of embodiment 41, wherein the intentionality of the consumer is determined based on analysis of the beacon data and of the consumer profile information, and wherein analysis of the realtime video feed is utilized to confirm the determined intentionality of the consumer.
88. The system of embodiment 41, further comprising:
   the offer determining component means, to:
      send the applicable offer in a message.
89. The system of embodiment 41, wherein the beacon data is obtained from the consumer device of the consumer who is entering in proximity to the retail establishment in a moving vehicle.
90. The method of embodiment 61, wherein the intentionality of the consumer is determined based on analysis of the beacon data and of the consumer profile information, and wherein analysis of the realtime video feed is utilized to confirm the determined intentionality of the consumer.
91. The method of embodiment 61, further comprising:
   executing processor-implemented offer determining component instructions to:
      send the applicable offer in a message.
92. The method of embodiment 61, wherein the beacon data is obtained from the consumer device of the consumer who is entering in proximity to the retail establishment in a moving vehicle.

In order to address various issues and advance the art, the entirety of this application for Realtime Realworld and Online Activity Correlation and Inventory Management Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a RROACIM individual and/or enterprise user, database configuration and/or relational model, data type, data transmission and/or network framework, syntax structure, and/or the like, various embodiments of the RROACIM, may be implemented that enable a great deal of flexibility and customization. For example, aspects of the RROACIM may be adapted for security and theft deterrence. While various embodiments and discussions of the RROACIM have included inventory, intentionality detection, and inventory management, however, it is to be understood that the embodiments described herein may be readily configured and/or customized for a wide variety of other applications and/or implementations.

What is claimed is:

1. A realtime realworld and device correlating apparatus, comprising:
a memory;
a component collection in the memory, including:
an offer determining component;
a processor disposed in communication with the memory, and configured to issue a plurality of processing instructions from the component collection stored in the memory,
wherein the processor issues instructions from the offer determining component, stored in the memory, to:
obtain, via processor, beacon data from a consumer device of a consumer entering in proximity to a retail establishment;
retrieve, via processor, consumer profile information of the consumer;
determine, via processor, an approximate consumer and consumer device location from the beacon data;
obtain, via processor, realtime video feed targeted at the approximate consumer and consumer device location;
generate, via processor, frame models of consumers in the targeted location from the obtained realtime video feed;
determine, via processor, which frame model is of the consumer by correlating the beacon data and the consumer profile information with movements and descriptions of frame models;
correlate, via processor, movements of the frame model with the consumer and consumer device;
determine, via processor, intentionality of the consumer; and
generate, via processor, an applicable offer for the consumer.

2. The apparatus of claim 1, wherein the beacon data includes a device identifier of the consumer device.

3. The apparatus of claim 1, wherein the beacon data includes location data associated with the consumer device.

4. The apparatus of claim 1, wherein the beacon data includes physiological data from a wearable device associated with the consumer.

5. The apparatus of claim 2, wherein instructions to retrieve consumer profile information of the consumer further comprise instructions to:
determine a consumer identifier of the consumer based on the device identifier of the consumer device; and
retrieve consumer profile information associated with the consumer identifier.

6. The apparatus of claim 1, wherein the consumer profile information includes demographic information associated with the consumer.

7. The apparatus of claim 1, wherein the consumer profile information includes consumer preference information associated with the consumer.

8. The apparatus of claim 3, wherein instructions to determine an approximate consumer and consumer device location from the beacon data further comprise instructions to determine geographic coordinates from GPS data included in the location data.

9. The apparatus of claim 1, wherein instructions to determine an approximate consumer and consumer device location from the beacon data further comprise instructions to determine the location of a beacon in communication range of the consumer device.

10. The apparatus of claim 9, wherein instructions to determine an approximate consumer and consumer device location from the beacon data further comprise instructions to determine signal strength between the beacon and the consumer device.

11. The apparatus of claim 1, wherein the realtime video feed comprises a plurality of simultaneous video feeds from a plurality of cameras.

12. The apparatus of claim 1, wherein instructions to determine which frame model is of the consumer further comprise instructions to:
classify a generated frame model according to type; and
determine whether the type associated with the generated frame model corresponds to the type specified in the consumer profile information of the consumer.

13. The apparatus of claim 1, wherein instructions to determine intentionality of the consumer further comprise instructions to predict whether the consumer is interested in purchasing a product.

14. The apparatus of claim 1, wherein instructions to determine intentionality of the consumer further comprise instructions to predict whether the consumer is unable to find a product.

15. The apparatus of claim 13, wherein instructions to generate an applicable offer for the consumer further comprise instructions to provide an electronic coupon associated with the product to the consumer.

16. The apparatus of claim 14, wherein instructions to generate an applicable offer for the consumer further comprise instructions to provide directions to the product to the consumer.

17. The apparatus of claim 15, wherein the electronic coupon is provided upon fulfillment of a condition by the consumer.

18. The apparatus of claim 17, wherein the condition is completion of a survey.

19. The apparatus of claim 1, further comprising:
the processor issues instructions from the offer determining component, stored in the memory, to:
generate a shelf tag update message for comparative information to be displayed to the consumer in proximity with a shelf tag targeted to receive the shelf tag update message.

20. The apparatus of claim 1, further comprising:
the processor issues instructions from the offer determining component, stored in the memory, to:
generate a shelf tag update message for offer information to be displayed to the consumer in proximity with a shelf tag targeted to receive the shelf tag update message.

21. The apparatus of claim 1, wherein the intentionality of the consumer is determined based on analysis of the beacon data and of the consumer profile information, and wherein analysis of the realtime video feed is utilized to confirm the determined intentionality of the consumer.

22. The apparatus of claim 1, further comprising:
the processor issues instructions from the offer determining component, stored in the memory, to:
send the applicable offer in a message.

23. The apparatus of claim 1, wherein the beacon data is obtained from the consumer device of the consumer who is entering in proximity to the retail establishment in a moving vehicle.

24. A processor-readable realtime realworld and device correlating non-transient physical medium storing processor-executable components, the components, comprising:
a component collection stored in the medium, including:
an offer determining component;
wherein the offer determining component, stored in the medium, includes processor-issuable instructions to:
obtain, via processor, beacon data from a consumer device of a consumer entering in proximity to a retail establishment;
retrieve, via processor, consumer profile information of the consumer;
determine, via processor, an approximate consumer and consumer device location from the beacon data;
obtain, via processor, realtime video feed targeted at the approximate consumer and consumer device location;
generate, via processor, frame models of consumers in the targeted location from the obtained realtime video feed;
determine, via processor, which frame model is of the consumer by correlating the beacon data and the consumer profile information with movements and descriptions of frame models;
correlate, via processor, movements of the frame model with the consumer and consumer device;
determine, via processor, intentionality of the consumer; and
generate, via processor, an applicable offer for the consumer.

25. A processor-implemented realtime realworld and device correlating system, comprising:
an offer determining component means, to:
obtain, via processor, beacon data from a consumer device of a consumer entering in proximity to a retail establishment;
retrieve, via processor, consumer profile information of the consumer;
determine, via processor, an approximate consumer and consumer device location from the beacon data;
obtain, via processor, realtime video feed targeted at the approximate consumer and consumer device location;
generate, via processor, frame models of consumers in the targeted location from the obtained realtime video feed;
determine, via processor, which frame model is of the consumer by correlating the beacon data and the consumer profile information with movements and descriptions of frame models;
correlate, via processor, movements of the frame model with the consumer and consumer device;
determine, via processor, intentionality of the consumer; and
generate, via processor, an applicable offer for the consumer.

26. A processor-readable realtime realworld and device correlating method, comprising:
executing processor-implemented offer determining component instructions to:
obtain, via processor, beacon data from a consumer device of a consumer entering in proximity to a retail establishment;
retrieve, via processor, consumer profile information of the consumer;
determine, via processor, an approximate consumer and consumer device location from the beacon data;
obtain, via processor, realtime video feed targeted at the approximate consumer and consumer device location;
generate, via processor, frame models of consumers in the targeted location from the obtained realtime video feed;
determine, via processor, which frame model is of the consumer by correlating the beacon data and the consumer profile information with movements and descriptions of frame models;
correlate, via processor, movements of the frame model with the consumer and consumer device;
determine, via processor, intentionality of the consumer; and
generate, via processor, an applicable offer for the consumer.
